(19) United States
(12) Patent Application Publication
(10) Pub. No.: US 2009/0243144 A1
(43) Pub. Date: Oct. 1, 2009

(54) SUPPORT ROLLER, WEB CONVEYANCE METHOD, SOLUTION CASTING METHOD AND SOLUTION CASTING APPARATUS

(75) Inventors: Daisaku Abiru, Minami-ashigara-shi (JP); Ryo Takeda, Minami-ashigara-shi (JP); Shinji Hikita, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/410,097

(22) Filed: Mar. 24, 2009

(30) Foreign Application Priority Data
Mar. 25, 2008 (JP) 2008-077127
Mar. 25, 2008 (JP) 2008-078300

(51) Int. Cl. B29C 39/16; B65H 20/00; F16C 13/00

(52) U.S. Cl. 264/212; 226/1; 492/34; 492/43; 425/224

(57) ABSTRACT

A support roller includes a roller body and a rotary shaft, and supports a web under conveyance with a peripheral surface of the roller body. The peripheral surface includes edge contact areas and a merchandise portion contact area. The edge contact areas make contact with edges in a width direction of the web. Each edge contact area has projections and recesses that have an arcuate cross section, and extend in the peripheral direction of the roller body. The projections and the recesses are arranged alternately in an axial direction. The projections are spaced at intervals from 0.01 mm to 2 mm. A height from a bottom of the recess to an apex of the projection is from 0.01 mm to 1 mm. The apex has a curvature radius in a range from 0.1 mm to 0.5 mm.

### FIELD OF THE INVENTION

The present invention relates to a support roller for supporting a web under conveyance, a web conveyance method, a solution casting method, and a solution casting apparatus.

### BACKGROUND OF THE INVENTION

A polymer film (hereinafter, films) is widely used as the optical function film, because of its excellent optical transparency, flexibility, lightweight and low-profile features. Especially, a cellulose ester film composed of cellulose acylate or the like is often incorporated to liquid crystal display devices and other polarization-related devices by reason of its excellent optical transparency and excellent optical isotropy. This feature offers the cellulose ester film as one of the best candidates for a support of an optical compensation film that improves the contrast of a display when viewed at an angle (viewing angle compensation).

A polarizing filter, one of the elements in the liquid crystal display device, is composed of a polarized film and a protective film. The polarized film is generally made of a polyvinyl alcohol (PVA) film that is stretched and dyed with iodine or a dichroic dye. As the protective film, a cellulose acylate film is often used since it can be pasted directly to the polarized film. Because of a significant impact of protective film's optical characteristics on polarized film's optical characteristics, a better optical isotropy and better optical characteristics are required to the protective film for the polarized film.

Improvement on the viewing angle has been a strong demand to the modern liquid crystal display devices, and therefore an ever-better optical isotropy is required to the protective film for the polarized film and the support for the optical compensation film.

There are two major types of film production methods, a melt-extrusion method and a solution casting method. The melt-extrusion method has a step of directly heating a polymer to melt, and a step of extruding the polymer melt from an extruder into a film. The melt-extrusion method is highly productive, and requires relatively low facility cost. At the same time, the melt-extrusion method provides poor control over film thickness, and also leaves minute lines (die-line or streak line) on the film. These drawbacks disqualify the melt-extrusion method as a choice for producing high quality films to be used as the optical function films. By contrast, the solution casting method allows producing the films with better optical isotropy, more even thickness and less foreign materials than the one that the melt-extrusion method produces. Therefore, the optical film for the display devices is produced by the solution casting method in most cases.

This type of optical function film, and magnetic tapes and photographic films are generally fabricated in the film producing apparatus which unwinds a web from a web roll continuously, applies a functional material, such as a magnetic material, a photosensitive material or an optical functional material, onto the web and dries it, and then winds the web again into a roll. This type of production facility is equipped with a plurality of rollers which are arranged along a conveyance path, and support and/or convey the web on their surfaces.

Roughly summarized, the solution casting method includes those steps of firstly dissolving cellulose triacetate or such polymer in a solvent of, such as, dichloromethane or methyl acetate so as to prepare a dope, secondly mixing one or more additives with this dope so as to prepare a casting dope, thirdly casting the casting dope onto a continuously running support (such as a casting drum or an endless band) from a discharge port of a casting die so as to form a casting film on the support, fourthly conveying the casting film with the support at a predetermined speed, fifthly peeling the casting film which has been cooled or dried to have a self-supporting property off from the support so as to obtain a wet film, sixthly conveying the wet film with support rollers (both drive and non-drive rollers) and free rollers (hereinafter collectively, guide rollers) from the support to a drying section, for a drying process to dry out the remaining solvent from the wet film, and finally winding the film into a roll (see, for example, Japanese Patent Laid-open Publication No. 2006-306025).

However, as a certain level of tensile force is applied to the wet film that contains a considerable amount of solvent, polymer molecules in the wet film are easily oriented to the direction of the tensile force. In other words, when the guide rollers are used to support and/or convey the wet film, the polymer molecules in the wet film are oriented to the conveyance direction. This will give a final film product a risk to have optical anisotropy.

Recent years, with significantly increased demand for optical films, the solution casting method is ever required to achieve higher productivity. However, as a film forming speed in the solution casting method is increased, the conveyance speed of the wet film, or namely a peripheral speed of the guide rollers, is also increased. The increase of the wet film conveyance speed or the guide roller peripheral speed allows the surrounding air to enter between the guide rollers and the wet film easily. Once entered between the guide rollers and the wet film, the air may trigger the wet film to slip on the guide rollers. Undesirably, slippage of the wet film ends up with leaving some scratches on the film surface, and also lowering a conveyance capacity of the guide rollers.

Moreover, the current trend in miniaturization for the devices that use or incorporate the magnetic tapes, the photographic films and the optical function films requires the web to be ever increasingly thin and flat. Accordingly, during the conveyance of the web, the web tends to slip on the rollers, and sometimes result in making scratches or wrinkles on the web. In addition, during conveyance of the web immediately after the application of the functional materials, the rollers may leave traces on a fresh coating layer (the phenomenon called roller mark transfer). These damages decrease the yield of product.

Not only in the coating process, but also in a producing process of the polymer film, the film slips on the rollers, and has scratches and wrinkles. Also, during the conveyance, the roller marks may be transferred either to a solvent-containing film or a highly-heated solvent-containing film in the solution casting method, and to a high temperature film reaching a nearly melting point in the melt extrusion method.

In view of these problems, there is disclosed a type of roller, mostly for thin webs with a thickness of 25 μm or below, which has a spiral groove and an intervening bump (see, for example, Japanese Patent Laid-open Publications No. 08-175727 and No. 10-077146). Also, there is disclosed a web support roller having tiny recesses on the surface (see, for example, Japanese Patent Laid-open Publication No. 2003-146505). In this web support roller, the average depth of the tiny recesses is within the range of not less than 5 μm and not more than 50 μm, and a flat section not having the recesses occupies not less than 50% and not more than 70% of the total area.

However, the rollers of the publications No. 08-175727 and No. 10-077146 are designed for thin films having a thickness of 25 μm or below, and suitable for the web before the functional material coating process. Namely, these rollers are hardly a solution for the roller mark transfer during conveyance of the web after the coating process.

As for the web support roller of the publication No. 2003-146505, the recesses are formed by blasting tiny particles, such as alumina sol or glass beads onto the roller surface. This blasting process ends up with disorder distribution of the recesses. In addition, because of irregularity of the particle diameters, the depth and the size of the recesses cannot be uniform. Beyond that, this web support roller cannot maintain a frictional force as the web is conveyed at high speed, and tends to slip underneath the web.

### SUMMARY OF THE INVENTION

In view of the foregoing, it is a main object of the present invention to provide a support roller capable of preventing scratches, wrinkles and roller mark transfer to a web, and a web conveyance method using this support roller.

Another object of the present invention is to provide a solution casting method and a solution casting apparatus which use this support roller to efficiently produce a polymer film having excellent optical isotropy.

In order to achieve the above and other objects, a support roller according to the present invention is disposed along side a conveyance path for a web so as to support the web. The support roller includes a solid cylinder shaped roller body having edge contact areas on its peripheral surface, and a plurality of projections provided in each of the edge contact areas. The edge contact areas make contact with edges in a width direction of the web. The projections extend in a peripheral direction of the roller body, and are arranged at intervals in a rotation axis direction of the roller body. When viewed in cross section taken along the rotation axis, each of the projections has an apex of substantially arcuate shape with a curvature radius of not less than 0.1 mm and not more than 0.5 mm. The intervals of the projections are not less than 0.01 mm and not more than 2 mm. Each projection has a height, from said apex to a bottom of a recess formed between adjacent projections, of not less than 0.01 mm and not more than 1 mm.

In another preferred embodiment of the present invention, the projections, when viewed in cross section taken along the rotation axis, have a flat apex which runs parallel to the rotation axis and has a length of not less than 0.05 mm and not more than 0.5 mm in the rotation axis direction. The interval of these projections is not less than 0.01 mm and not more than 2 mm in the rotation axis direction. Each projection has a height, from said apex to a bottom of a recess formed between adjacent projections, of not less than 0.01 mm and not more than 1 mm.

Preferably, the apex of every projection projects more outwardly than a merchandise portion contact area of the roller body, which makes contact with a merchandise portion extending across the web except the edges. It is also possible that the projections are provided as a group in a first edge contact area on one end of the roller body, and in a second edge contact area on the other end of the roller body, and that the projections are formed into spirals with opposite curving directions, and that roller body is oriented such that the projection groups come away from each other as the web advances in a conveyance direction.

A web conveyance method according to the present invention includes a step of supporting a web under conveyance with one of the aforesaid support rollers. This web has a thickness of not less than 20 μm and not more than 200 μm.

In yet another preferred embodiment of the present invention, the support roller includes a roller body, tapered sections disposed on both ends in a rotation axis direction of the roller body, a constant diameter section disposed on the center in the rotation axis direction of the roller body, and a plurality of projections on a peripheral surface of the roller body. Each of the tapered sections has an edge contact area which makes contact with one of side edges in a width direction of the web, and increases its diameter gradually toward an extreme end of the roller body. The constant diameter section has a merchandise contact area which makes contact with a merchandise portion that covers all across the web except the edges. The constant diameter section is formed to keep a constant diameter throughout its length in the rotation axis direction. The projections are provided in the edge contact areas. These projections extend along a peripheral direction of the roller body, and are arranged at regular intervals in the rotation axis direction of the roller body. When viewed in cross section taken along the rotation axis, the projections have an apex of substantially arcuate shape.

Preferably, the interval of the projections is not less than 0.01 mm and not more than 2 mm. It is preferred that each projection has a height of, from the apex to a bottom of a recess which are formed between adjacent said projections, not less than 0.01 mm and not more than 1 mm. A calculation value of (De−Dc)/Dc is preferably not less 0.001 and not more than 0.1, where Dc denotes a diameter of the tapered section at a border to the constant diameter section, and De denotes a diameter of the tapered section at the extreme end of the roller body.

A solution casting apparatus according to the present invention includes a continuously running support, a casting film forming device, a drying device and the aforesaid support roller. The casting film forming device casts a dope of a polymer and a solvent onto the support so as to continuously form a casting film. The drying device dries the casting film which has been peeled off as a wet film from the support. The support roller supports the wet film under conveyance to the drying device.

Preferably, a temperature of the support is substantially constant in a range of not less than −15° C. and not more than 0° C. In addition, the drying device is preferably a pin tenter which holds both edges in a width direction of the wet film, and dries it.

A solution casting method according to the present invention includes a casting step, a peeling step, a drying step and a conveying step. In the casting step, a dope of a polymer and a solvent is cast onto a running support to form a casting film continuously. In the peeling step, the casting film is peeled off as a wet film from the support. In the drying step, the wet film is dried in the drying device. In the conveying step, the wet film is conveyed to a drying device while being supported by the aforesaid support roller.

According to the support roller of the present invention, the projections in the edge contact areas of the roller body prevent slippage and the roller mark transfer of the web during conveyance. It is therefore possible to support the web without making scratches and wrinkles on the web. The size and shape of the projections and the recesses can be determined as needed to form a contact area above a certain level between the web and the peripheral surface of the roller body, and to give a cross-sectional area above a certain level to each recess when cut along an axial direction of the roller body. This configuration allows keeping a web retention force at or above a certain level, and also preventing the slippage of the web as it releases the air from between the web and the peripheral surface of the roller body.

Even when the web is conveyed at high speed, the gaps between the web and the support roller surely release the air, and the slippage of the web due to the air can be prevented. As a result, it is possible to avoid damaging the web, and also convey the web at high speed.

Additionally, the tapered sections serve to produce a tensile force in the web width direction during conveyance. In the event that the polymer molecules are biased to the conveyance direction in the web under conveyance, a desired amount of tensile force can be applied in the web width direction substantially orthogonal to the conveyance direction. It is therefore possible to reduce the anisotropy of the in-plane retardation Re in the conveyance direction. As a result, a polymer film with extremely low optical anisotropy is produced easily and efficiently.

According to the web conveyance method of the present invention, the web is protected from scratches, wrinkles and roller mark transfer. The yield of product is therefore increased, and the production cost is reduced.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating a web conveyance device according to the present invention;

FIG. 2 is a plan view of a support roller, viewed from underneath;

FIG. 3 is an elongated partial cross-sectional view of a first support roller, taken along an axial direction thereof;

FIG. 4 is an elongated partial cross-sectional view of the first support roller supporting a wet film, taken along the axial direction;

FIG. 5 is an elongated partial cross-sectional view of a second support roller, taken along the axial direction;

FIG. 6 is an elongated partial cross-sectional view of a third support roller, taken along an axial direction thereof;

FIG. 7 is an elongated partial cross-sectional view of a fourth support roller, taken along an axial direction thereof;

FIG. 8 is a plan view of a fifth support roller, viewed from underneath;

FIG. 9 is an explanatory view illustrating a solution casting apparatus equipped with the support rollers;

FIG. 10 is an explanatory view of a solution casting apparatus according to another embodiment of the present invention;

FIG. 11 is an explanatory view illustrating a first drying chamber;

FIG. 12 is a plan view of a sixth support roller, viewed from underneath;

FIG. 13 is a cross-sectional view around an edge contact area of the sixth support roller, taken along an axial direction of a roller body;

FIG. 14 is across-sectional view of the sixth support roller in supporting a wet film;

FIG. 15 is a cross-sectional view around an edge contact area of a seventh support roller, taken along an axial direction of a roller body;

FIG. 16 is a cross-sectional view around an edge contact area of a eighth support roller, taken along an axial direction of a roller body;

FIG. 17 is a cross-sectional view around an edge contact area of a ninth support roller, taken along an axial direction of a roller body;

FIG. 18 is a plan view of a tenth guide roller, viewed from above the wet film; and

FIG. 19 is an explanatory view illustrating a first drying chamber with a different roller configuration.

### DETAILED DESCRIPTION OF THE PREFERRED EMBODIMENTS

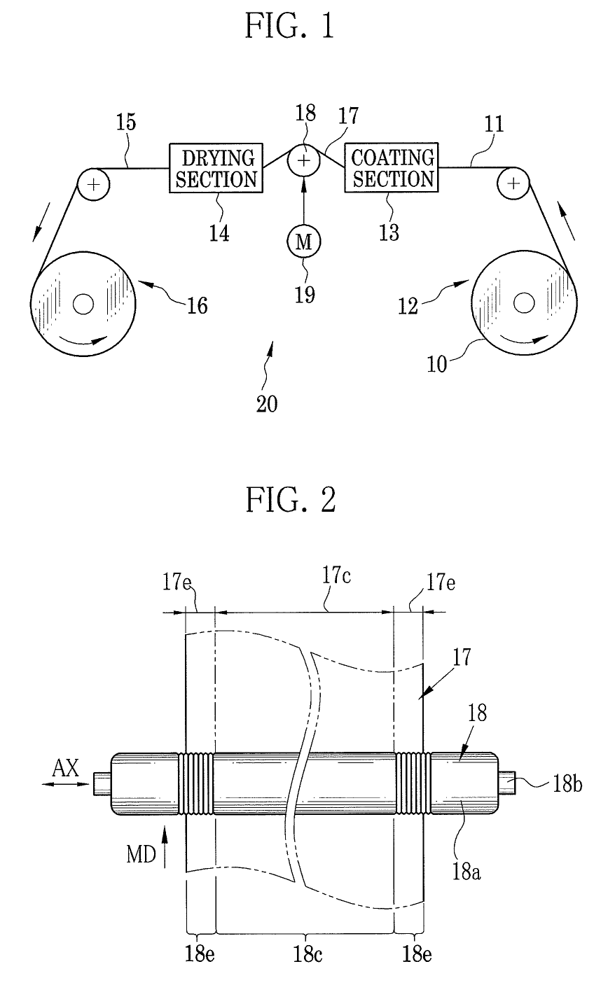

Referring to FIG. 1, a web conveyance device 20 includes a feeding section 12 for continuously unwinding and feeding a web 11 from a web roll 10, a coating section 13 for coating a surface of the web 11 with functional material to form a functional coating layer, a drying section 14 for drying the coating layer, and a winding section 16 for winding the web 11 having the coating layer into a roll again. In this embodiment, the web 11 having one or more dried coating layers is referred to as a film 15. As the functional layers may be a magnetic coating layer, an optical function coating layer and the like. Hereafter, functional materials include a magnetic material for magnetic tapes, a photosensitive material for photographing films, and an optical function material for liquid crystal display devices.

The web 11 is a flexible support with, for example, a width of not less than 100 mm and not more than 3000 mm, a length of not less than 100 m and not more than 5000 m, a thickness not less than 20 μm and not more than 200 μm, and a surface roughness Ra of not less than 1 nm and not more than 100 nm. More preferably is the width of the web 11 not less than 1000 mm and not more than 2500 mm. The web 11 may preferably be made of a plastic film; a paper; a paper coated or laminated with α-polyolefin of carbon number 2 to 10, such as polyethylene, polypropylene, ethylene-butene polymer; and a metal foil of aluminum, copper or tin. In addition, the plastic film may be any of the film made of plastic film of polyethylene terephthalate, polyethylene-2,6-naphthalate, cellulose diacetate, cellulose triacetate, cellulose acetate propionate, polyvinyl chloride, polyvinylidene chloride, polycarbonate, polyimide, or polyamide.

Disposed between the coating section 13 and the drying section 14 is a support roller 18 which conveys the web 11 with one or more fresh coating layers (hereinafter, wet film 17) applied in the coating section 13. The support roller 18 is rotated by a motor 19 at the same speed as the wet film is conveyed.

As shown in FIG. 2, the support roller 18 is composed of a roller body 18a and a pair of shafts 18b partially fitting into both end faces of the roller body 18a. Formed substantially into a solid cylinder, the roller body 18a supports the wet film 17 on its peripheral surface, and conveys the wet film 17 in a direction of an arrow MD (hereinafter, MD direction). The roller body 18a and the shafts 18b are preferably be made of high corrosion-resistant materials, such as aluminum, iron, stainless and carbon fiber reinforced plastics (CFRP). The roller body 18a is not necessarily limited to a solid cylinder, but also a hollow cylinder.

The roller body 18a has two of edge contact areas 18e and a merchandise portion contact area 18c on the peripheral surface. The edge contact areas 18e are so positioned to support both edge portions (hereinafter, edges) 17e of the wet film 17 in an axial direction AX of the support roller 18 (hereinafter, AX direction). The merchandise portion contact area 18c is so positioned to support a merchandise portion 17c extending between the edges 17e of the wet film 17.

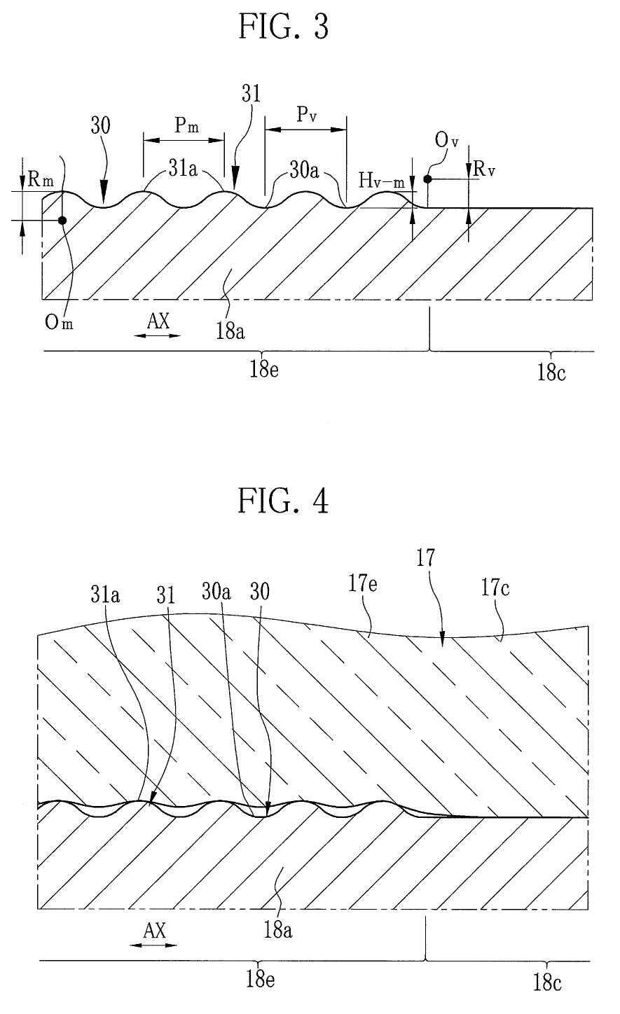

As shown in FIG. 3 and FIG. 4, each of the edge contact areas 18e has a plurality of recesses 30 and projections 31 with an arcuate cross section in the AX direction of the roller body 18a. The recess 30 and projection 31 alternate with each other in the AX direction. The recesses 30 and projections 31 are cut and shaped with accuracy by, for example, precision lathe having a cutting bite.

A distance between apexes 31a of the adjacent projections 31, or namely a pitch Pm is not less than 0.01 mm and not more than 2 mm. With the pitch Pm under 0.01 mm, not only the lathe work becomes difficult to increase the production cost, but also the support roller produces little effect. On the other hand, with the pitch Pm over 2 mm, the slippage and the roller mark transfer are more likely to occur. It is also preferred to leave a distance between bottoms 30a of the adjacent recesses 30, or namely a pitch Pv, of not less than 0.01 mm and not more than 2 mm. More preferably, the pitch Pv of the recesses 30 and the pitch Pm of the projections 31 are both not less than 0.3 mm and not more than 0.5 mm.

A height Hv-m from the bottom 30a to the apex 31a is not less than 0.01 mm and not more than 1 mm. With the height Hv-m under 0.01 mm, an air release effect would hardly be expected during support of the wet film 17, and the slippage occurs easily. With the height Hv-m over 1 mm, on the other hand, the lathe work becomes difficult and, if it is carried out, increases the production cost to make the roller expensive. Here, the term “air” means the air that is introduced between the peripheral surface of the roller body 18a and the wet film 17, due to the running action of the wet film 17 and the rotation of the roller body 18a. It is highly preferred that the height Hv-m is not less than 0.02 mm and not more than 0.1 mm.

A distance between a center Om in the cross section circle of the projection 31 and the apex 31a, or namely a curvature radius Rm of the projection 31 is not less than 0.1 mm and not more than 0.5 mm. With the curvature radius Rm under 0.1 mm, a contact area to the wet film 17 becomes so small to cause slippage. It is preferred to give the recess 30 a distance between a center Om in the cross section circle of the recess 30 and the bottom 30a, or namely a curvature radius Rv, of not less than 0.1 mm and not more than 0.5 mm. It is more preferred that the curvature radii Rv, Rm of the recess 30 and the projection 31 are both not less than 0.2 mm and not more than 0.4 mm.

Next, the operation of the web conveyance device 20 is described. Firstly, as shown in FIG. 1, the web 11 is unwound from the web roll 10 in the feeding section 12, and conveyed to the coating section 13. In the coating section 13, the web 11 is coated with a certain functional material, and conveyed as the wet film 17 to the support roller 18.

The wet film 17 is conveyed by the support roller 18 to the drying section 14. In the drying section 14, the wet film 17 is dried to be the film 15, and wound again into a roll in the winding section 16. This roll of the film 15 is transported to the next working stage, and becomes a product film.

As shown in FIG. 3 and FIG. 4, as the support roller 18 supports and/or conveys the wet film 17 on the peripheral surface of the roller body 18a, the surrounding air enters between the peripheral surface of the roller body 18a and the wet film 17. Because of its flexibility, the wet film 17 curves along the surface of the projections 31 and bulges into the recesses 30. The projections 31 are formed into a predetermined shape and dimension, so that they can produce a strong frictional force against the wet film 17 while preventing the roller mark transfer. The recesses 30, On the other hand, is down from the apex 31a by the height Hv-m, and release the air from between the support roller 18 and the wet film 17. With the support roller 18, it is possible to prevent the slippage and the roll marks due to the entry of air, and therefore possible to support and/or convey the wet film 17 without scratching and wrinkling.

Although the slippage and the roll marks could be prevented more effectively by providing the projection 31 across the edge contact areas 18e and the merchandise portion contact area 18c, the shaping process of the projections 31 requires a high level of accuracy and leads to increase the production cost. By contrast, the present invention, where the projections 31 are provided only across the edge contact areas 18e, enables producing an inexpensive support roller that offers the ability to prevent the slippage and the roll marks.

Generally, the slippage due to the entrance of air will occur when the support roller's conveyance speed, or a peripheral speed of the roller body 18a, is 50 m/min or above. According to the present invention, by contrast, the support roller can still prevent the slippage and the roll marks during support and/or conveyance of the wet film 17 even at a high conveyance speed.

In some cases, depending on the material and property, the web 11 is subjected to a certain level of tension in the MD direction as it touches the peripheral surface of the support roller. This tension may stretch the wet film 17 too much to provide intended character and quality of the final film 15. According to the present invention, because of the projections 31 in the edge contact areas 18e of the support roller 18, the wet film 17 is steadily supported at the edges 17e by the edge contact areas 18e, while at the merchandise portion 17c is kept separated or lightly supported on the merchandise portion contact area 18c due to the air that has entered in between. Therefore, even if the web 11 would lower its character or quality during the contact with the peripheral surface of the support roller 18, this negative effect applies only within the edges 17e, and intended character and quality are maintained in the merchandise portion 17c. For example, as an optical film such as a polarizer protection film or an optical compensation film, the film 15 needs to provide the retardation that is highly isotropic or lies within a predetermined range. And this retardation is changed by the tension against the wet film 17 in the production process. When the support roller 18 is used as a conveyer for the wet film 17, the tension against the wet film 17 and the resultant stretching during the conveyance affects mostly to the edges, and little to the merchandise portion. As a result, it is possible to produce the film 15 with a desired retardation.

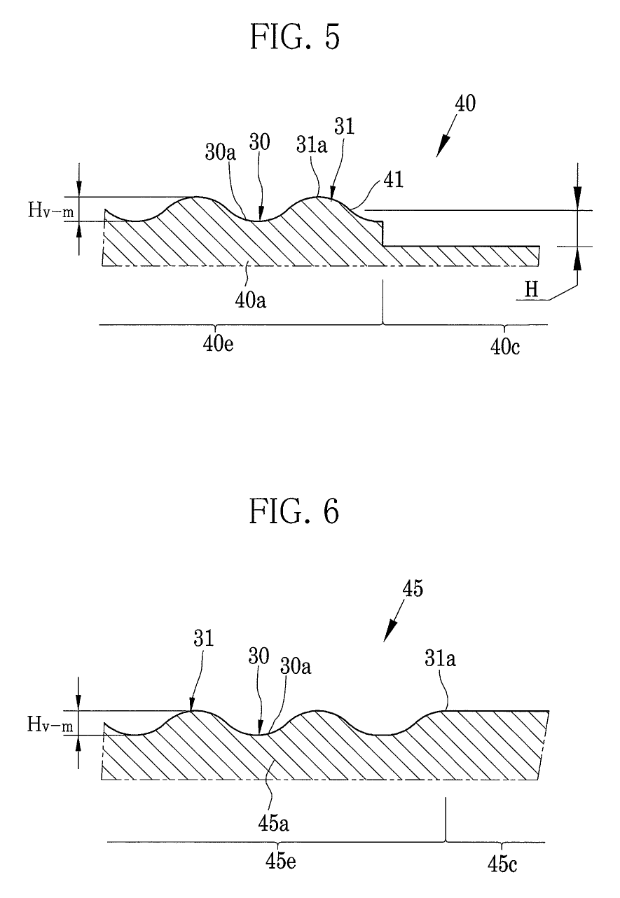

In the above embodiment, as shown in FIG. 3 and FIG. 4, the bottoms 30a are substantially level with the merchandise portion contact area 18c to the radial direction of the roller, and the apex 31a of each projection 31 juts out beyond the merchandise portion contact area 18c. The support roller 18 may, however, be substituted for a support roller 40 or 45 as shown in FIG. 5 and FIG. 6. Hereafter, the support rollers 40, 45 are described in detail, where the elements similar to those in the above embodiment are denoted by the same reference numerals, and the explanation thereof is omitted.

As shown in FIG. 5, the support roller 40 has a roller body 40a. Similar to the roller body 18a, the roller body 40a has a merchandise portion contact area 40c and two of edge contact areas 40e, in which the recesses 30 and the projections 31 are provided. The bottom 30a of each recess 30 is not level with, but raised higher than the merchandise portion contact area 40c. Because of the projections 31 that project above the merchandise portion contact area 40c, the support roller 40 can produce a strong frictional force against the wet film 17. The roller body 40a may be shaped by firstly forming the recesses 30 and the projections 31 across the edge contact areas 40e of the roller body 40a, and then grinding the merchandise portion contact area 40c until it becomes lower than the bottoms 30a to the radius direction. It is preferred to set a height H in the radius direction of not less than 0.01% and not more than 2% to the radius of the roller body 40a between the merchandise portion contact area 40c and a halfway point 41 that is up from the bottom 30a by substantially a half-length of the height Hv-m.

As shown in FIG. 6, the support roller 45 has a roller body 45a. Similar to the roller body 18a, the roller body 45a has a merchandise portion contact area 45c and two of edge contact areas 45e, in which the recesses 30 and the projections 31 are provided. The apex 31a of each projection 31 is substantially level with the merchandise portion contact area 45c.

In the above embodiments, the recess 30 and the projection 31 are arranged so that the bottom 30a or the apex 31a lies on the border of the edge contact area to the merchandise portion contact area. They may, however, be arranged so that a halfway point between the bottom and the apex lies on the border of the edge contact area to the merchandise portion contact area.

While, in the above embodiments, the recesses 30 and the projections 31 are provided all across the edge contact areas 18e, they may be provided partially in the edge contact areas 18e. Additionally, where the roller mark transfer or such negative effect would scarcely occur, the recesses 30 and the projections 31 may also be provided partially or all across the merchandise portion contact area 18c. It is also possible to introduce an edge slitting device, somewhere between the drying section 14 and the web supporting roller or between the drying section 14 and the winding section 16, which cuts off the edges of the wet film 17 or the film 15. Even with this configuration, the roller marks may possibly be transferred to the edges. In that case, those edges can be simply removed with the edge slitting device.

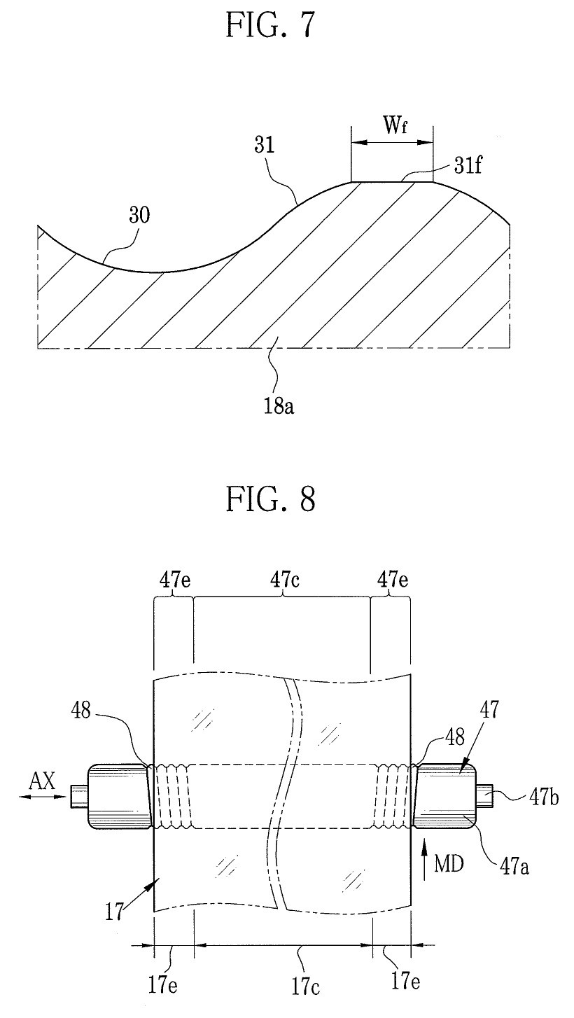

The recess 30 does not necessarily have a substantially arcuate cross section as in the above embodiments, but may have a rectangular, triangle or other shaped cross section, insofar as the gap is created to release the air when the wet film 17 is placed on the projection 31. For example, as shown in FIG. 7, the apex 31a of the projection 31 may be shaped into a smooth surface 31f that extends substantially in the AX direction. This smooth surface 31f may be shaped by, for example, grinding the apex 31a of with a grinder after the recess 30 and projections 31 have been formed. The smooth surface 31f serves to prevent streaky roller marks. The smooth surface 31f also has a width Wf of not less than 0.05 mm and not more than 0.5 mm in the axial direction of the roller. The smooth surface 31f with this width makes it easy to produce a frictional force against the wet film 17 and to ever effectively prevent the streaky roller marks at a time. With the width Wf under 0.05 mm, the apex cannot completely grinded for certain accuracy of the projection 31. With the width Wf over 0.5 mm, the recesses 30 and the projections 31 cannot be arranged at the aforesaid pitches. More preferably, the width Wf is not less than 0.1 mm and not more than 0.3 mm.

The recesses 30 and the projections 31 are not necessarily be discrete circles as in the above embodiments, but may be spiral lines. As shown in FIG. 8, a support roller 47 has a pair of spiral sections 48 on the roller surface in edge contact areas 47e that touch the edges 17e. Each spiral section 48 has a spirally-extending projection and an intervening recess. These recess and projection have the same structure as the recess 30 and the projection 31 respectively. Additionally, the projections of the pair of spiral sections 48 have opposite curving direction to each other, and gradually come away from each other on the support roller 47 toward the downstream side of the MD direction. This configuration serves to prevent the slippage and the roll marks, and also the wrinkles of the wet film 17. It should be noted that the spiral section 48 may have more than one spiral projection.

While the above embodiments are directed to the support roller 18 that is a driven roller activated by the motor 19, the present invention is also applicable to a free roller with no drive source. Although the support roller 18 is arranged in the manner that it is partially wrapped with the wet film 17 at a predetermined wrap angle as shown in FIG. 1, it may be arranged for the wrap angle of 0°.

The single support roller 18 is used in the above embodiments, but it is possible to use a plurality of support rollers. For example, one or more additional support rollers may be provided in the upstream or downstream side or both sides from the support roller 18 in the conveyance direction of the wet film 17. In this case, some of the additional rollers may be free rollers that rotate freely, while the others are drive rollers coupled to the motor.

The support roller 18 is applicable to a solution casting apparatus and a melt-extrusion apparatus. For the solution casting apparatus, the support roller 18 is provided to convey those two types of web, peeled off from a support, which are so-called a wet film containing solvent and a film obtained be drying the wet film. In the solution casting apparatus, a dope of polymer and solvent is cast on the casting support to form thereon a cast film, which is then peeled off as the wet film from the support. This wet film is conveyed to a drying chamber by the support roller 18. In the drying chamber, the wet film is dried to evaporate the remaining solvent. The film thus obtained is wound into a roll by a winding device. This roll of film can be set as the web roll 10 to the web conveyance device 20 shown in FIG. 1. For the melt-extrusion apparatus, on the other hand, the support roller 18 conveys the film of polymer that has been melted and extruded into a thin film by a melt-extruder.

It is preferred for the film produced by the solution casting apparatus to have a length of at least 100 m in a longitudinal direction (casting direction). A width of the film is preferably 600 mm or above, and more preferably in the range not less than 1400 mm and not more than 2500 mm. Nonetheless, the present invention also has effect to the films with the width over 2500 mm. Further, the present invention is applicable to the production of thin films with a thickness not less than 40 μm and not more than 60 μm.

In the solution casting method, the wet film contains the solvent, and also is heated to accelerate drying. In the melt-extrusion method, the film reaches to a high temperature nearly the melting point when it is extruded from the melt-extruder. The support roller 18 can convey these solvent-containing web and high temperature web without a slip, and prevent scratches, wrinkles and roller mark transfer. Hereafter, as an example of the support roller 18 to film production apparatus, a solution casting apparatus is described.

[Material]

A dope may be made from those polymers and solvents that are conventionally used for the film production by the solution casting method. Among these polymers, cellulose acylate and cyclic polyolefin are preferably used. To any kind of polymers, the configuration of the production apparatus and the procedure of the production method are essentially the same. Therefore, the explanation below is directed to cellulose acylate as polymer.

Among cellulose acylate, preferable is the one that meets the following conditions (I) to (III) for a ratio in esterification of hydroxyl group of cellulose with carboxylic acid, or namely a degree of acyl substitution (hereinafter, acylation degree):

2.5≦A+B≦3.0 (I)

0≦A≦3.0 (II)

0≦B≦2.9 (III)

wherein A and B are both acylation degree, and the acyl group of A is acetyl group, while the acyl group of B is the acyl group of carbon number 3 to 22.

Cellulose has glucose units making β-1,4 bond, and each glucose unit has a free hydroxyl group at second, third, and sixth positions. Cellulose acylate is a polymer in which a part of or the whole of the hydroxyl groups are esterified so that the hydrogen is substituted by the acyl group with two or more carbons. As one ester group in a glucose unit is esterified to 100%, the substitution degree becomes 1. Therefore, in cellulose acylate, the substitution degree becomes 3 when each of the ester groups at the second, third and sixth positions is esterified to 100%.

Here, the acylation degree at the second, third and sixth positions are denoted as DS2, DS3 and DS6 respectively. A total acylation degree, the value of DS2+DS3+DS6, is preferably in the range of 2.00 to 3.00, more preferably in the range of 2.22 to 2.90, and most preferably in the range of 2.40 to 2.88. In addition, DS6/(DS2+DS3+DS6) is preferably 0.28 or above, and more preferably 0.30 or above, and yet more preferably in the range of 0.31 to 0.34.

These acyl groups may be a singular kind, or more than two different kinds. When two or more kinds of acyl groups are used, one of them is preferably an acetyl group. In a case where a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.22 to 2.90, and more preferably in the range of 2.40 to 2.88. In addition, DSB is preferably at least 0.30, and more preferably at least 0.70. In the DSB, the degree of the substitution of the hydroxyl group at the sixth position is at least 20%, preferably at least 25%, more preferably at least 30%, and most preferably at least 33%. Furthermore, the value of DSA+DSB, in which the hydroxyl group is at the sixth position in cellulose acylate, is preferably at least 0.75, more preferably at least 0.80, and most preferably at least 0.85. This type of cellulose acylate serves to produce a highly-soluble dope, and a low-viscosity and easily-filtered dope. For combination with a non-chlorine organic solvent, this type of cellulose acylate is particularly preferred.

The acyl group of carbon number 2 or above may be either aliphatic group or aryl group, and is not especially limited. Examples of the cellulose acylate include alkylcarbonyl ester, alkenylcarbonyl ester, aromatic carbonyl ester, aromatic alkylcalbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

Cellulose acylate is described in more details in Japanese Patent Laid-open Publication No. 2005-104148, paragraphs [0140]-[0195], and these details also apply to the present invention.

The solvents for the dope preparation may be aromatic hydrocarbon (for example, benzene, toluene, and the like), halogenated hydrocarbon (for example, dichloromethane, chlorobenzene, and the like), alcohol (for example, methanol, ethanol, n-propanol, n-butanol, diethylene glycol, and the like), ketone (for example, acetone, methyl ethyl ketone, and the like), ester (for example, methylacetate, ethylacetate, propylacetate, and the like), ether (for example, tetrahydrofuran, methyl cellosolve, and the like), and the like. Here, the term “dope” means a polymer solution or dispersion solution that is obtained by dissolving or dispersing a polymer in a solvent.

A preferable solvent, among the above compounds is the halogenated hydrocarbon of carbon atom number 1 to 7, and the most preferable solvent is dichloromethane. From the standpoints of peelability of a casting film from the support, a mechanical strength of the film, and optical properties of the film, it is preferred to use one or more kinds of alcohol of carbon atom number 1 to 5, together with dichloromethane. A content of alcohol is preferably in the range of 2 wt % to 25 wt %, and more preferably in the range of 5 wt % to 20 wt % relative to the whole solvent. Exemplary alcohols may be methanol, ethanol, n-propanol, iso-propanol, n-butanol, and the like, and especially methanol, ethanol, n-butanol, and more preferably a mixture of them.

Where a negative effect on the environment should be minimized, the dope may be produced from other than dichloromethane. A preferably solvent, in this case, would be ether of carbon atom number 4 to 12, ketone of carbon atom number 3 to 12, ester of carbon atom number 3 to 12, or a mixture of these. For example, a solvent mixture may contain methylacetate, acetone, ethanol, and n-butanol. These ether, ketone and ester can have a cyclic structure. Also, a compound having two or more functional groups (namely, —O—, —CO—, and —COO—) of ether, ketone and ester can be used as the solvent. In addition, the solvent may have other functional groups, such as an alcoholic hydroxyl group, in its chemical structure.

The dope may be combined with those popular additives such as plasticizers, UV absorbents (UV agents), deterioration inhibitors, lubricating agents, and peeling improvers where needed. For example, the plasticizer can be any of phosphoric acid ester plasticizers, such as triphenyl phosphate and biphenyl diphenyl phosphate, phthalic acid ester plasticizers such as diethyl phthalate, or polyester polyurethane elastomer.

As well as the solvent and the additives, other ingredients such as a plasticizer, a deterioration inhibitor, a UV-absorbing agent, an optical anisotropy controller, a retardation controller, dye, a matting agent, a release agent are also detailed in the aforesaid publication No. 2005-104148, paragraphs [0196] to [0516] in the same publication, and theses details also apply to the present invention.

Using the aforesaid materials, a dope with a cellulose acylate concentration of not less than 5 wt % and not more than 40 wt % is produced. Particularly, a preferable cellulose acylate concentration is not less than 15 wt % and not more than 30 wt %, and a more preferable cellulose acylate concentration is not less than 17 wt % and not more than 25 wt %. It is also preferred that an additive concentration is not less than 1 wt % and not more than 20 wt % relative to a total solid content.

Several techniques for the dope preparation, such as a dissolution method for raw materials, a filtering method, a defoaming method and an adding method are detailed in the publication No. 2005-104148, paragraphs [0517] to [0616], and these details also apply to the present invention.

[Film Production Method]

The present invention is not limited to the solution casting apparatus 50. The solution casting apparatus 50 includes a casting chamber 53 where a dope 51 of cellulose acylate and solvent is cast to from a film of cellulose acylate containing the solvent, or in other words a wet film 52, a first drying chamber 56 for drying while conveying the wet film 52, a tenter 57 for holding both side edges of the wet film 52, out of the first drying chamber 56, and conveying and drying it, an edge slitting device 58 for cutting off the side edges of the wet film 52, a second drying chamber 61 for drying while conveying the wet film 52 into a cellulose acylate film (hereinafter, film) 59 of which the solvent is almost dried out, a cooling chamber 62 for cooling down the film 59, a neutralization device 63 for removing electrostatic charges from the film 59, a knurling roller pair 66 for embossing both lateral ends of the film 59, and a winding chamber 67 for winding up the film 59.

The casting chamber 53 has a casting die 71 for discharging the dope 51 and a casting drum 72 as the casting support. Preferably, the casting die 71 is of coat hanger type. The casting die 71 is equipped with a temperature controller (not shown) that adjusts the temperature of the casting die 71 to keep the dope 51 at a predetermined temperature.

Although it is not particularly limited, a width of the casting die 71 in this embodiment is 1.1-2.0 times as wide as the finished film 59. Additionally, for the sake of thickness adjustment of a bead during discharge, it is preferred to provide the casting die 71 with a plurality of evenly-spaced thickness adjustment bolts (heat bolts) that adjust a clearance of a slit.

The casting drum 72, or the casting support, is attached to a shaft (not shown). Under the control of a controller (not shown), the casting drum 72 rotates about the shaft. It is a peripheral surface of this rotating drum 72 that supports the dope 51. A width of the casting drum 72, though not particularly limited, is 1.1-2.0 times as wide as a casting width of the dope 51 in this embodiment. The peripheral surface of the casting drum 72 is finished to a surface roughness of 0.01 μm or below, and chrome plated. The casting drum 72 is connected to a heat transfer medium circulator (not shown), which adjusts the temperature of a heat transfer medium, and circulates it in a channel inside the casting drum 72, so that the peripheral surface of the casting drum 72 is kept substantially constant within a predetermined temperature range. The temperature of the peripheral surface of the casting drum 72 is preferably in the range of not lower than −15° C. and not higher than 0° C., but it may be changed as needed according to the type of solvents, the type of solid components, the density of the dope 51 and other conditions.

The casted dope 51 forms a casting bead that bridges the casting die 71 and the casting drum 72, and on the casting drum 72 is formed a casting film 78. Due to the contact with the peripheral surface of the casting drum 72, the casting film 78 is cooled down into a gel state, and has a self-supporting property. On an upstream side from the casting bead, there is provided a decompression chamber 76 which decreases an atmospheric pressure around an upstream area of the casting bead so as to stabilize the shape of the casting bead.

Preferably, the pressure in the upstream area is reduced by 2000 Pa to 10 Pa than the downstream area from the casting bead. For better shaping of the casting bead, a suction device (not shown) that draws the air around both edges of the casting bead is preferably be provided at the edges of the casting die 71. In this case, a suction air volume is preferable in the range of 1 L/min to 100 L/min.

The casting chamber 53 is equipped with a temperature controller 77 that keeps a predetermined internal temperature of the casting chamber 53, and a condenser (not shown) that condenses and recovers the solvent evaporated from both the dope 51 and the casting film 78. In addition, a recovery device (not show) to recover solvent-condensed liquid is provided outside the casting chamber 53. The solvent, recovered with the recovery device, is refined and reused as the solvent for dopes.

The casting chamber 53 is also equipped with a peel roller 85. The peel roller 85 peels off the casting film 78 that has now had the self-supporting property from the casting drum 72, and supports the resultant wet film 52. The weight of residual solvent in the casting film 78, at the time of peeling, is preferably in a range from 10 to 200 as the weight of the solid contents is represented as 100.

In place of the casting drum 72, it may be possible to use a pair of backup rollers and a band that bridges them. In this case, to make the casting film 78 develop the self-supporting property, the casting film 78 is dried out until the solvent is evaporated.

The first drying chamber 56 is equipped with a blower (not shown). This blower blows air at the temperature ranging from 20° C. to 250° C. The first drying chamber 56 also has the support roller 18 that guides the wet film 52 to the tenter 57. It is the support roller 18 which conveys the wet film 52 stably without slipping and prevents scratches and wrinkles of the wet film 52, even when the wet film 52 is heated to such a high temperature as 100° C. or above by the blower or it contains the solvent. The support roller 18 scarcely presses foreign matters onto the wet film 52, nor does it put marks on the wet film 52. Beyond that, the support roller 18 prevents the roller mark transfer on the film. The support roller 18 applies the tension of, preferably, 50 N/m or below to the wet film 52. This amount of tension allows the support roller 18 to convey the wet film having the residual solvent content of not less than 100 wt % and not more than 250 wt % without stretching it in the conveyance direction. Here, the residual solvent content is a dry basis value, and calculated by a formula; {(x−y)/y}×100, wherein “x” is the weight of a wet film at the time of sampling, and “y” is the dry weight of the sampled film.

It is possible to provide more than one support roller 18 in the first drying chamber 56. Further, the rollers in the first drying chamber 56 can be all the support rollers 18, or the part of the rollers can be the support rollers 18. It is preferred that at least all the drive rollers, among the whole rollers, are the support rollers 18, and more preferred that free rollers, as well as the drive rollers, are also the support rollers 18.

In the first drying chamber 56, the rotating speed of the rollers along the conveyance path is controlled so that the rollers on the downstream side rotate faster than those on the upstream side. This control allows applying a draw tension, or in other words a tensile force in the conveyance direction, to the wet film 52, and prevents sagging and deformation of the wet film 52.

Conveyed to the tenter 57, thee wet film 52 is held on the both side edges by holders (not shown), and as the holders move, the wet film 52 is conveyed. During the conveyance, the wet film 17 is dried. The holder may be a clip that seizes the end portion of the wet film 52, or a set of pins that pierce the end portion. For the case where the casting drum 72 is used as the casting support, and where the casting film 78 is cooled down and peeled as most of the solvent is not yet evaporated, the pins are suitable as the holders of the tenter 57. In contrast, for the case where the band is used as the casting support, and where the casting film is peeled as the part of the solvent is evaporated, the clips are suitable as the holders of the tenter 57. In the tenter 57, the wet film 52 is kept at the temperature of not less than 120° C. and not more than 180° C., and drying is accelerated.

The edges of the wet film 52, having been dried in the tenter 57, are cut off by the edge slitting device 58. The removed edges are sent through a cutter blower (not shown) to a crusher 89, in which the edges are crushed into chips. These chips are reused for the preparation of the dopes.

The wet film 52 that has been cut along the edges is conveyed to the second drying chamber 61, and dried further during conveyance. The internal temperature of the second drying chamber 61, though not particularly limited, is preferably in a range from 60° C. to 140° C. Similar to the first drying chamber 56, the support roller 18 is provided along the conveyance path in the second drying chamber 61. It is the support roller 18 which conveys the wet film 52 stably without slipping and prevents scratches and wrinkles of the wet film 52, even when the wet film 52 is heated to such a high temperature as 100° C. or above by the blower or it contains the solvent. The support roller 18 scarcely presses foreign matters onto the wet film 52, nor does it put marks on the wet film 52. Beyond that, the support roller 18 prevents the roller mark transfer on the film.

The rollers in the second drying chamber 61 can be all the support rollers 18, or the part of the rollers can be the support rollers 18. It is preferred that at least all the drive rollers, among the whole rollers, are the support rollers 18, and more preferred that free rollers, as well as the drive rollers, are also the support rollers 18.

It is preferred to cool down the film 59 that has been dried to approximately a room temperature in the cooling chamber 62. The neutralization device 63 is a so-called compulsory neutralization device such as a neutralization bar, and reduces an electrostatic voltage of the film 59 down to a predetermined range. Specifically, it is preferred to reduce electrostatic voltage of the film 59 to a range in a range from −3 kV to +3 kV.

The knurling roller pair 66 embosses the lateral ends of the film 59 to provide them with knurls. In this embossing process, a height of the knurls is preferably controlled to a range from 1 μm to 200 μm.

The winding chamber 67 has a winding roller 92 for winding up the film 59, and a press roller 93 that adjusts a tension on the film 59 during the wind up.

Although not shown, the solution casting apparatus 50 has many other rollers along the conveyance path. The support roller according to the present invention is also applicable to these rollers, whereby it is possible to convey the wet film 52 and the film 59 by far more stable than the conventional apparatus, and also to prevent scratches, wrinkles and roller mark transfer of the wet film 52. The rollers along the conveyance path are typically free rollers and drive rollers, and the support roller according to the present invention is significantly effective when it is used as the drive rollers.

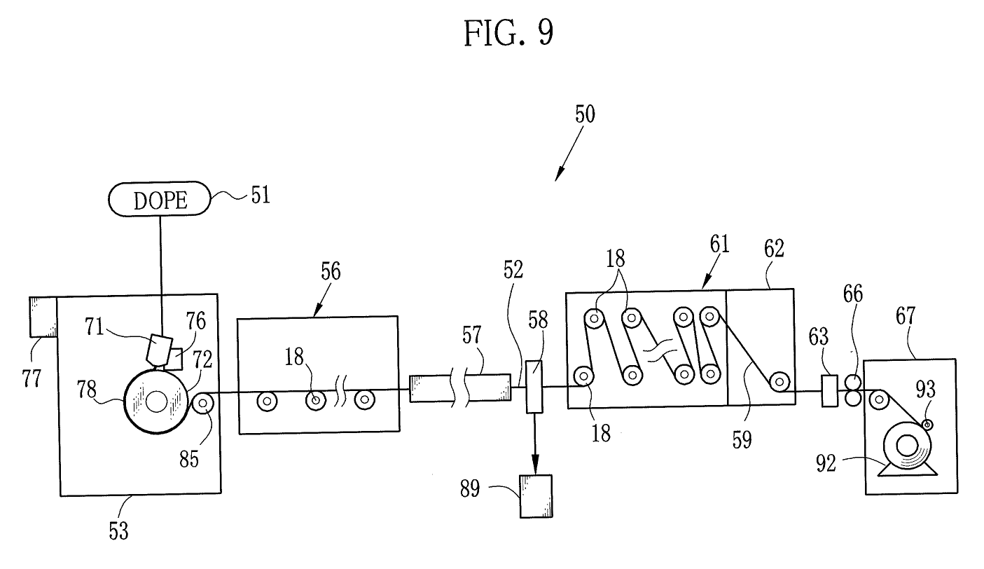

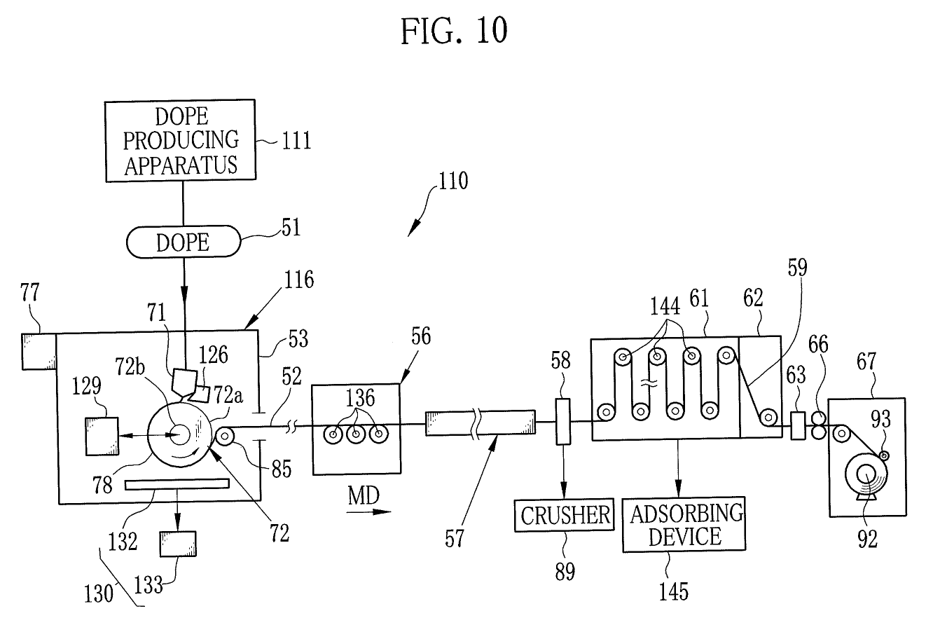

Next, another type of support roller is described. Similar to the solution casting apparatus 50 shown in FIG. 9, a solution casting apparatus 110 in FIG. 10 is a polymer film producing apparatus that uses the solution casting method to produce a polymer film. Therefore, in FIG. 10, the elements similar to those in the solution casting apparatus 50 are designated by the same reference numerals, and the detailed explanations thereof are omitted.

The solution casting apparatus 110 is connected through a pipe to a dope producing apparatus 111, which supplies the dope 51.

A casting device 116 has a decompression chamber 126, a heat transfer medium circulator 129 and a condensing devise 130 in the casting chamber 53. The casting die 71 is an extrusion die that discharges the dope.

The peel roller 85 is substantially constant in diameter throughout the length. The peel roller 85 peels off the casting film 78 from a peripheral surface 72a of the casting drum 72, and guides a band of this peeled casting film 78, which has now became the wet film 52, to the first drying chamber 56 through an outlet port of the casting chamber 53. The temperature controller 77 adjusts an internal temperature of the casting chamber 53. The condensing devise 130 includes a condenser 132 and a recovery device 133. The condenser 132 condenses and liquefies the solvent vapor in the casting device 116. The recovery device 133 recovers the liquefied solvent.

The casting die 71 is provided at the tip thereof with a discharge port in the shape of a horizontally elongated slit to discharge the dope 51, and the casting drum 72 is positioned below this discharge port. The dope 51 droops down form the discharge port, and flows in the shape of a thin sheet to the peripheral surface 72a of the casting drum 72. The casting die 71 is made of such a material as SUS 316 that provides a high corrosion resistance and a low coefficient of thermal expansion against mixed liquid of electrolyte solution, dichloromethane and methanol.

The casting drum 72 has a cylindrical shape. Connected to a drive unit (not shown), the casting drum 72 is rotated at a constant rate in a counterclockwise direction around a rotary shaft 72b in FIG. 10. Because of this rotation, the peripheral surface 72a runs at a speed ranging from 10 m/min to 300 m/min. The peripheral surface 72a is chromium plated, offering adequate corrosion resistance and strength. As for the dimension and material of the casting drum 72, although not particularly limited, the casting drum is preferably 1.1-2.0 times as wide as the casting width of the dope 51, and preferably made of a high corrosion-resistant and high intensity material. Also, the running speed of the peripheral surface 72a is preferably 100 m/min or above.

The heat transfer medium circulator 129 is connected to the casting drum 72. Similar to the above embodiment, the heat transfer medium circulator 129 circulates a heat transfer medium to keep the temperature of the peripheral surface 72a of the casting drum 72 at a range of, for example, not less than −15° C. and not more than 0° C. For smoothness of the casting film 78, the peripheral surface 72a may preferably be polished.

The dope 51, out of the casting die 71, turns into the casting film 78 on the peripheral surface 72a. Then, cooled down on the peripheral surface 72a, the casting film 78 transforms in a gel state. This casting film 78 travels in the rotating direction of the casting drum 72.

The aforesaid gel state includes not only that a colloid liquid hardens to a jelly, but also that the liquid has lost fluidity. Here, the term “having lost fluidity” means those situations where, as for high-molecular solute, the solvent has lost fluidity in the molecular chains of the solute, and the liquid results in losing fluidity accordingly, and where, as for low-molecular solute, the molecules of the solvent and the solute interact with each other, and the liquid results in losing fluidity accordingly.

The decompression chamber 126 is located on an upstream side from the discharge port in the rotating direction of the casting drum 72, and decreases an atmospheric pressure behind a casting bead that determines a flow of the dope 51 from the discharge port to the casting drum 72. The casting bead is therefore negatively pressurized on the rear side. This serves to stabilize and fix a landing position of the casting bead on the peripheral surface 72a of the casting drum 72. In this embodiment, the decompression chamber 126 decreases pressure by 2000 Pa to 50 Pa.

The peel roller 85 is located on a downstream side from the casting die 71 in the rotating direction of the casting drum 72. The peel roller 85 peels off the casting film 78 as the wet film 52 from the casting drum 72, and sends out this wet film 52 in the MD direction through the outlet port of the casting chamber 53 to the first drying chamber 56.

As described, the residual solvent content in the wet film 52 immediately after the peeling, or the web in a gel state, needs to be not less than 100 wt % and not more than 250 wt %.

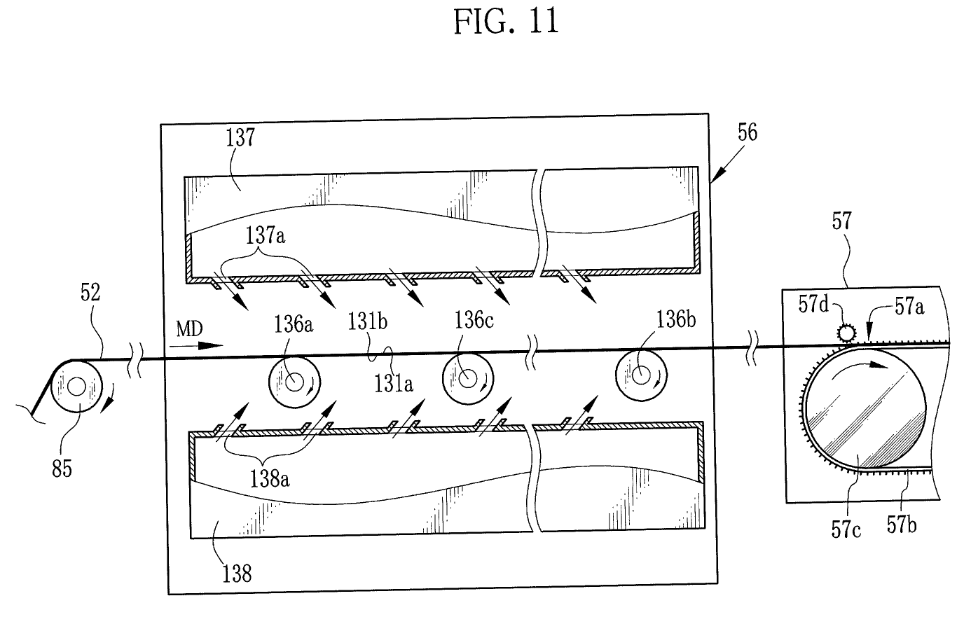

As shown in FIG. 10 and FIG. 11, the first drying chamber 56 is equipped with a plurality of support rollers 136. Where need, along with the support rollers 136, a pair of ducts 137, 138 may be provided in the first drying chamber 56. The support rollers 136 comprise two of drive support rollers 136a, 136b and a free support roller 136c. These rollers 136a-136c support an under surface 131b of the wet film 52 with their peripheral surfaces, and the drive support rollers 136a, 136b convey the wet film 52 in the MD direction.

The drive support rollers 136a, 136b are located in series from the upstream to the downstream on the MD direction, and driven by a motor.

The ducts 137, 138 have sets of slits 137a, 138a for blowing off cool air respectively. The duct 137 is arranged to orient the slits 137a to a upper surface 131a of the wet film 52, and the duct 138 is arranged to orient the slits 138a to the under surface 131b of the wet film 52. The ducts 137, 138 blow off the cool air, which is controlled by a controller (not shown) to adjust temperature, humidity and a condensation point of solvent vapor to certain ranges, through the slits 137a, 138a to the surfaces 131a, 131b of the wet film 52. This blow of cool air accelerates the gelatification of the wet film 52 in the first drying chamber 56. The cool air may preferably be kept constant at within a temperature range of −20° C. and 50° C. so as to keep the gel state of the wet film 52. In place of or in combination with the slits 137a, 138a, openings in a rectangular, circular or elliptical shape can be provided.

While two of the ducts 137, 138 are provided alongside the surfaces 131a, 131b of the wet film 52 in the above embodiment, the duct may be singular and located alongside one of the surfaces. In addition, the cool air may be delivered to either all across the width of the wet film 52 or only the center portion, or both or either end in the width direction of the wet film 52. Also, the cool air can be blown either from a substantially vertical direction to the surface of the wet film 52, from the MD direction, or from both sides of the wet film 52. Furthermore, it is possible to select the surface of the wet film 52 which touches the peripheral surface 72a of the casting drum 72 as the upper surface 131a, and select the other air-exposed surface as the under surface 131b, or select them conversely.

For the purpose of keeping the web film 131 in the gel state, the surface temperature of the support rollers 136 that touch the wet film 52 may be kept substantially constant at a range from −20° C. to 50° C. under the control of a not-shown controller.

[Tenter]

The tenter 57 has a chain 57b, a pair of pulleys 57c, and a pair of clamping brushes 57d. The pulleys 57c are each located in a holding area 57a and a releasing area (not shown). The clamping brushes 57d are located on the upstream side in the holding area 57a, and each positioned near one of lateral ends of a conveyer path of the wet film 52. Under the control of a not-shown controller, the pulleys 57c rotate about their rotary shafts. The rotation of the pulleys 57c leads the chain 57b to rotate endlessly across the holding area 57a and the releasing area. The wet film 52, in the holding area 57a, is pushed by the clamping brushes 57d against pins provided on the chain 57b, and these pins pierce the wet film 52. In this manner, the wet film 52 in the holding area 57a is held on the both ends by the pins of the chain 57b. Eventually, in the releasing area, the wet film 52 is release from the pins. As it has passed through the holding area 57a and the releasing area, the wet film 52 out of the casting device 116 is conveyed as a film 120 to the edge slitting device 58.

The tenter 57 is also provided with one or more ducts (not shown). These ducts deliver specifically-conditioned dry air to the wet film 52. This dry air evaporates the solvent from the wet film 52, and leads the wet film 52 to dry. For efficient evaporation of the solvent from the wet film 52, the temperature of the dry air is preferably within the range not less than 130° C. and not more than 190° C.

It is possible to provide a stretching device between the tenter 57 and the edge slitting device 58. This stretching device may be either the one which has a pair of rails that come apart from each other from the entrance to the exit and stretch the width of the film, or the one which has a shrinking device to stretch the width of the film. While the tenter 57 is explained as a pin tenter which has the pins as a holding member, the tenter may be a clip tenter which has plural clips that seize, as a holding member, the edges of the wet film 52. Also, it is possible to use the pin tenter and the clip tenter together.

As shown in FIG. 10, the edge slitting device 58 cuts off the edges of the wet film 52 which are damaged by the contact with the support roller 136 and by the piercing of the pins. The wet film 52, with the size edges being cut off, is conveyed to the second drying chamber 61. The removed edges (film edge debris) are crushed into chips, which are then reused as a material for the dope 51.

The drying chamber is equipped with a plurality of pass rollers 144. The wet film 52 is hooked around these pass rollers 144, and the both surfaces of the wet film 52 are dried out completely. During the drying, the solvent is evaporated from the wet film 52. This evaporated solvent is recovered with an adsorbing device 145 that is provided outside the first drying chamber 56. The dried-out wet film 52 is guided as the film 59 to the cooling chamber 62, and cooled down to a room temperature.

On the downstream of the cooling chamber 62 in the MD direction, there is provided a neutralization device 63. The neutralization device 63 removes electrostatic charges from the film 59. Next to the neutralization device 63, a knurling roller pair 66 is provided. The knurling roller pair 66 embosses the film 59 after neutralization to provide both lateral ends of the film 59 with knurls.

The winding chamber 67 is located downstream of the knurling roller pair 66 in the MD direction. The winding chamber 67 has a winding roller 92 and a press roller 93. The winding roller 92 winds up the film 59 conveyed from the knurling roller pair 66. The press roller 93 pushes the film 59 against the winding roller 92 during the wind-up.

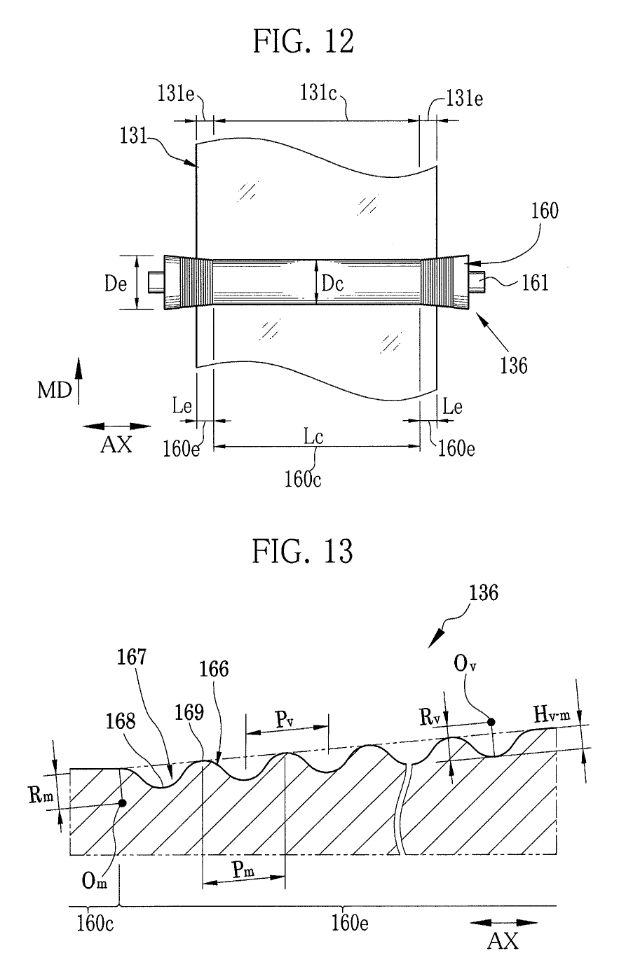

Next, the support rollers 136 are described in detail. As shown in FIG. 12 and FIG. 13, each support roller 136 is composed of a roller body 160 and a shaft 161 that is an axis of rotation. The support roller 136 is arranged to render the shaft 161 in the AX direction that is orthogonal to the MD direction. The roller body 160 and the shaft 161 are preferably be made of high corrosion-resistant materials, such as aluminum, iron, stainless and carbon fiber reinforced plastics (CFRP). In addition, it is preferred to finish the surface of the support roller 136 with a Teflon (registered trademark) coating.

The roller body 160 has two of edge contact areas 160e and a merchandise portion contact area 160c on the peripheral surface. The edge contact areas 18e make contact with edges 131e of the wet film 52, and the merchandise portion contact area 160c makes contact with a merchandise portion 131c of the wet film 52. A diameter Dc of the merchandise portion contact area 160c is substantially constant in the AX direction. By contrast, a diameter of each edge contact areas 160e is gradually increased, or tapered, from Dc to De, toward the end of the roller body 160.

When introduced to convey the wet film 52, the support roller 136 having the above-configured roller body 160 applies a tensile force, directed from the center to the ends of the AX direction, to the wet film 52, especially to the edges 131e. The strength of the tensile force can be determined by the amount of taper. This taper amount, determined by a formula of, for example, (De−Dc)/Dc, is preferably not less than 0.001 and not more than 0.1, and more preferably not less than 0.005 and not more than 0.02. In addition, along the AX direction, a sum of two lengths Le for which the edge contact areas 160e overlap the wet film 52 and a length Lc of the merchandise portion contact area 160c is preferable not less than 1.8 m and not more than 2.2 m. For the sake of film production efficiency, each of the length Le is preferably 200 mm or below.

In each of the edge contact areas 160e, a plurality of projections 166 are arranged at regular intervals along the AX direction. These projections 166 extend in the peripheral direction of the roller body 160. Between the adjacent projections 166, a recess 167 is provided. By contrast, the merchandise portion contact area 160c has a smooth surface.

The projections 166 and the recesses 167 have a semicircular cross section, and cut and shaped with accuracy by, for example, precision lathe having a cutting bite. A line of an apex 169 of each projection 166 (hereinafter, apex line) runs orthogonal to the rotation axis of the roller. A line of a bottom 168 of each recess 167 runs parallel to the apex line. It may be possible to arrange the apex lines in a V shape across the width of the roller, so that the wet film 52 can be stretched gradually in the film width direction.

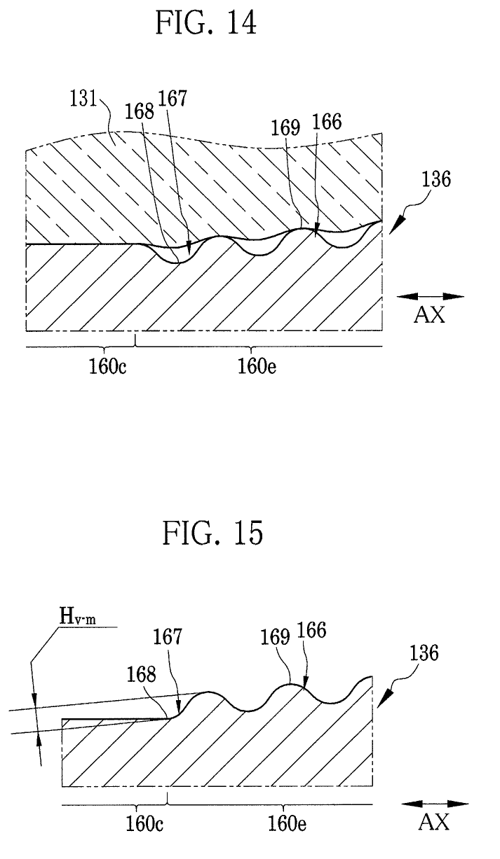

As shown in FIG. 14, the wet film 52 is so-called a gel film, and as it is supported by the support roller 136, the edges 131e curve along the surfaces of the projections 166 and bulge loosely into the recesses 167 while creating gaps with the recesses 167. During the support roller 136 conveys the wet film 52, the surrounding air enters between the support roller 136 and the wet film 52. The projections 166 support the edges 131e of the wet film 52, and the recesses 167 release the air through the gaps. Therefore, it is prevented the slippage of the edges 131e and the edge contact areas 160e due to the entry of air, while the wet film 17 as whole is stably supported and conveyed by the projections 166. The support rollers 136 according to the present invention prevent the slippage of the wet film 52 and stably convey the wet film 52 even when the air enters between the wet film 52 and the support rollers 136.

Since the merchandise portion contact area 160c has the smooth surface instead of having the projections 166 and the recesses 167, no scratch is made nor is a mark of the projection 166 transferred on a merchandise portion of the wet film 52, as the support roller 136 conveys the wet film 52.

Even with the support roller 136, the wet film 52 is subjected to a tension in the MD direction, while is however weaker than the conventional flat roller produces. This tension leads polymer molecules of the wet film 52 to be oriented in the MD direction. The oriented polymer molecules serve to increase a refractive index Ny of the film in the MD direction, and vary an in-plane retardation Re that is determined by multiplication of a film thickness and a birefringence |Nx−Ny|. The support roller 136 is able to give the wet film 52 a tension in the AX direction that is substantially orthogonal to the MD direction, as it conveys the wet film 52. Additionally, the amount of the tension in the AX direction can be changed as needed by adjusting the taper amount of the support roller 136. Accordingly, with the support roller 136, it is possible to prevent the variation of the in-plane retardation Re during the conveyance, and also prevent wrinkles and curling of the wet film 52.

It is true that the projections 166 may actually damage or wrinkle the edges 131e of the wet film 52. This is, however, still not the problem because the damaged edges 131e are removed by the edge slitting device 58, and a remaining merchandise portion 131c becomes a final product, the film 59.

The projection 166 and the recess 167 are nearly identical to the projection 31 and the recess 30 of the support roller 18. As the curvature radius Rm becomes larger, a grip on the wet film 52 increases and the slippage is more prevented. For the wet film 52 of this embodiment, the curvature radius Rm as large as 0.5 mm will provide an adequate grip. It is preferred to give the recess 167 a distance between a center Om in the cross section circle of the recess 167 and the bottom 168, or namely a curvature radius Rv, of not less than 0.1 mm and not more than 0.5 mm. It is more preferred that the curvature radii Rv, Rm of the recess 167 and the projection 166 are both not less than 0.2 mm and not more than 0.4 mm.

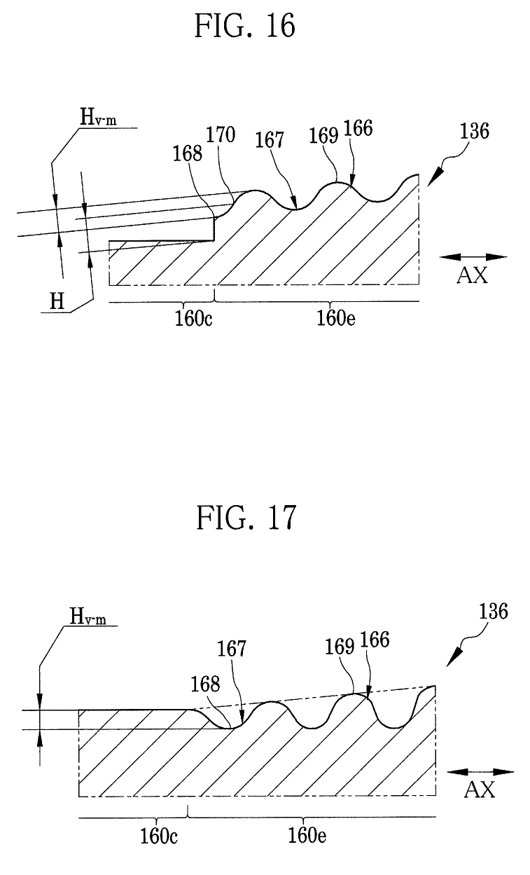

The projections 166 and the recesses 167 may be formed in the edge contact areas 160e in the manner shown in FIG. 15 or FIG. 16. These types of roller body 160 maybe obtained either by firstly shaping the projections 166 and the recesses 167 in the edge contact areas 160e and then polishing or grinding the edge contact areas 160e down to the same level as the bottom 168 of the recess 167, or by shaping the surface of the support roller 136 using a stepped roller that has large diameter portions to correspond to the edge contact areas 160e. In both cases, a better grip is provided because the apex 169 of each projection 166 projects more upwardly from the merchandise portion contact area 160c than the roller bodies 160 shown in FIG. 13 and FIG. 14. It is preferred to set a height H in the axial direction of not less than 0.01% and not more than 2% to the radius of the roller body 160 between the merchandise portion contact area 160c and a halfway point 170 that is up from the bottom 168 by substantially a half-length of the height Hv-m.

While the height Hv-m between the bottom 168 and the apex 169 is substantially constant across the roller width in the above embodiment, the projections 166 and the recesses 167 maybe formed as shown in FIG. 17, so that the height Hv-m is larger at the both sides than at the center in the AX direction.

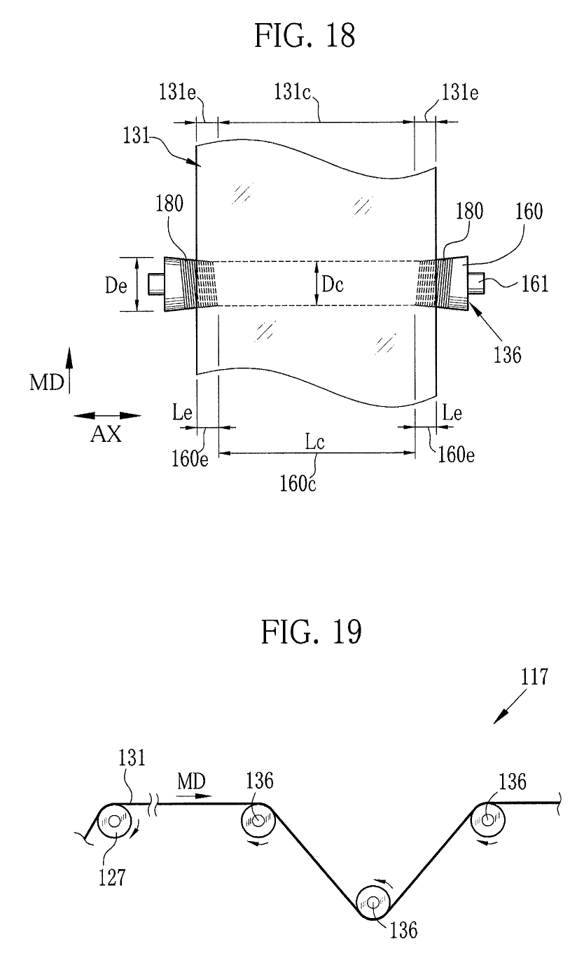

The projections 166 and the recesses 167 are not necessarily be discrete circles as in the above embodiments, but may be one or more spiral lines. While the lines of the projections 166 and the recess 168 run orthogonal to the rotation axis, these lines may cross the rotation axis obliquely. In this case, as shown in FIG. 18, spiral sections 180 may be provided in such a manner that an interval of the apex line pair in the AX direction becomes smaller on the downstream side in the MD direction than on the upstream side.

Although the support rollers 136 are horizontally aligned along the first drying chamber 56 as shown in FIG. 11, they may be arranged in a zigzag form as shown in FIG. 19. In addition to the support rollers 136, a plurality of conventional flat rollers may be arranged in a zigzag form in FIG. 19.

Unlike the above embodiments, shown in FIG. 10 to FIG. 18, where the projections 166 and the recesses 167 are provided to every support roller 136, they may be provided to at least one of the support rollers 136a-136c. The support roller to have the projections 166 and the recesses 167 can either be a drive roller or a free roller.

It is preferred to regulate the width of the edges 131e within the range of not less than 1% and not more than 10% to the whole width of the wet film 52. It is also preferred to give the same width to all the projections 166.

In this manner, a highly-smooth film 59 can be produced stably at high speed. The present invention allows producing the film 59 with a length of 100 m or above in the MD direction and a width ranging from 100 mm to 3000 mm in the AX direction. The present invention is particularly effective on a film with a length ranging from 100 m to 5000 m, and a film with a width ranging from 1400 mm to 1800 mm. A thickness of the film 59 is preferably in a range from 20 μm to 500 μm, and more preferably in a range from 30 μm to 300 μm, and yet more preferably in a range from 35 μm to 200 μm. Nonetheless, the present invention is also effective when the film 59 is as thin as 15-100 μm.

While the casting support is the casting drum in the above embodiment, it may be an endless belt that runs endlessly around a pair of rotating member.

In the above embodiments shown in FIG. 10 to FIG. 18, the casting film 78 is cooled down on the running support until the self-supporting property is developed. However, the casting film 78 may be dried to develop the self-supporting property. In this case, the residual solvent in the wet film 52 immediately after the peeling is preferably not less than 70 wt % and not more than 100 wt % on a dry basis. When the casting film 78 has dried for the self-supporting property, it is possible to blow the wet film 52 with dry air at a temperature of not less than 20° C. and not more than 250° C. This dry air may be blown to the wet film 52 in the same manner as the aforesaid cool air.

While the support rollers 136 in the above embodiment are provided in the first drying chamber 56, they may be provided in the tenter 57, the edge slitting device 58 and the second drying chamber 61 insofar as they are arranged along the conveyance path for the wet film 52. Also, the support rollers 136 may be provided at a connecting path between the conveyance paths. Although the above embodiment is directed to the polymer film production apparatus, the present invention is also applicable to those support rollers which convey a gelled web of a solute and a solvent. The gelled web of a solute and a solvent includes not only the web during production, but also those strips of gelled sheets and films which, as a product, contain a solute and a solvent.

While a single layer film is produced from a single kind dope in all the above embodiments, the present invention is also effective for the production of a multi-layered cast film. In this case, any known method is used for casting a desired number of dopes simultaneously or sequentially and the method to be used is not particularly limited. Details for the structures of a casting die, a decompression chamber and a support, a co-casting process, a peeling process, a stretching process, a drying condition in each process, a handling methods, curling, a winding methods after the correction of planarity, a solvent recovering method and a film recovering method are described in the Japanese Patent Laid-Open Publication No. 2005-104148, paragraphs [0617] to [0889]. These details also apply to the present invention. Also, a performance of a finished film, degrees of curling, thickness, and measuring methods thereof are disclosed in the same publication No. 2005-104148, paragraphs [1073] to [1087]. These descriptions apply to the present invention.

It is preferable to perform surface treatment to at least one of the surfaces of the produced film so as to improve adhesion property of the produced film to optical parts of, for example, a polarizing filter. It is preferable to perform at least one of the following treatments as the surface treatment: for example, vacuum glow discharge, plasma discharge under the atmospheric pressure, UV-ray irradiation, corona discharge, flame treatment, acid treatment and alkali treatment.

When used as a base and provided with a desired function layer on one or both surface, the finished film turns into a functional film. Examples of the functional layer are an antistatic layer, a curable resin layer, an anti-reflection layer, an easy-adhesion layer, an anti-glare layer, optical compensation layer and the like. For example, an anti-reflection film is produced by providing the anti-reflection layer to the produced film 37. The anti-reflection film prevents reflection of light and serves to achieve high image quality. The above described functional layers for imparting various functions to the film and forming methods thereof are detailed in paragraphs [0890] to [1072] of the publication No. 2005-104148. These descriptions also apply to the present invention. The polymer film according to the present invention is particularly suitable for liquid crystal display devices of TN, STN, V, OCB and reflection types, which are described in the publication No. 2005-104148, paragraphs [1088] to [1265].

Next, dope materials for the present invention are explained in detail.

As a dope material, cellulose acylate is suitable for producing highly-transparent films. An exemplary cellulose acylate is cellulose of lower fatty acid ester, such as cellulose triacetate, cellulose acetate propionate and cellulose acylate butyrate. Among these, cellulose acylate is preferably for better transparency, and particularly preferable is cellulose triacetate (TAC). It should be noted that the dope of this embodiment includes cellulose triacetate as a polymer. It is preferred in such cases that more than 90 wt % of TAC is taken up with particles of 0.1 mm to 4 mm. The detail of cellulose acylate is as described above.

[Experiment 1]

To demonstrate the effect of the support roller 18, a first experiment was conducted under those conditions. Firstly, as the support roller 18, a stainless (non-plated) roller body 18a with 300 mm diameter and 1000 mm long was prepared and combined with the shafts 18b. This roller body 18a was processed to have the recesses 30 and the projections 31 with the pitches Pv, Pm of 1 mm, the height Hv-m of 0.5 mm and the curvature radii Rv, Rm of 0.3 mm.

Then, with the solution casting apparatus 50 shown in FIG. 9, the film 59 was produced from the dope 51. Specifically, the dope 51 was cast from the casting die 71 onto a casting support so as to form a casting film 78. The casting support was the peripheral surface of the casting drum 72. The temperature of the casting drum 72 was controlled so that the peripheral surface was kept substantially constant at the temperature of not less than −15° C. and not more than 0° C. Due to the contact with the peripheral surface of the casting drum 72, the casting film 78 was cooled down into a gel state to have a self-supporting property. The casting film 78 having the self-supporting property was peeled off from the casting drum 72, and the wet film 52 was obtained. Immediately after the peeling, the wet film 52 contained the residual solvent of not less than 100 wt % and not more than 250 wt %. Using the support roller 18, the wet film 52 was conveyed to the tenter 57, under those conveyance conditions in which a tension was 50 N/m, and a peripheral speed of the support roller 18 was kept at a range from 20 m/min to 60 m/min. In this pin tenter, the wet film 52 was dried. The wet film 52 was then cut off its edges in the edge slitting device 58, and dried further into the film 59 in the second drying chamber 61. This dried-out film 59 was conveyed through the cooling chamber 62 and others to the winding chamber 67. The film 59 thus produced had a width of 2000 mm and a thickness of 80 μm. The film 59 also had an in-plane retardation Re of 4 mm, and a thickness direction retardation Rth of 45 nm.

The in-plane retardation Re was measured by the steps of cutting the film 59 into a piece of 70 mm×100 mm, conditioning this film piece under a temperature of 25° C. and a humidity of 60% RH for two hours, measuring from a vertical direction the retardation value of the conditioned film piece at a wavelength of 632.8 nm using an automatic birefringence meter (KOBRA21DH, Oji Scientific Instrument Col, Ltd.), and calculating the Re by a formula below using the extrapolated value of the measured retardation value:

Re=|nMD−nTD|×d

where nMD was the refractive index in the conveyance direction, nTD was the refractive index in the film width direction, and d was the thickness of the film.

The thickness direction retardation Rth was measured by the steps of cutting the film 59 into a piece of 30 mm×40 mm, conditioning this film piece under a temperature of 25° C. and a humidity of 60% RH for two hours, measuring the retardation value of the conditioned film piece at a wavelength of 632.8 nm firstly from a vertical direction and then while tilting the film piece using an ellipsometer (M150, JASCO Corporation), and calculating the Rth by a formula below using the extrapolated values of the measured retardation values:

Rth={(nMD+nTD)/2−nTH}×d

where nTD was the refractive index in the film thickness direction.

The following is the composition of the polymer solution (dope) that was used for the production of the polymer film.

[Dope Preparation]

The dope 51 was prepared by adding a certain volume of the solid contents (solute) containing:

| | | |
|---|---|---|
| Cellulose triacetate (substitution degree of 2.85) | 100 | pts. wt |
| Plasticizer A (triphenyl phosphate) | 7.1 | pts. wt |
| Plasticizer B (biphenyl diphenyl phosphate) | 3.6 | pts. wt |
| into the mixed solvent of: | | |
| Dichloromethane | 80 | pts. wt |
| Methanol | 13.5 | pts. wt |
| N-butanol | 6.5 | pts. wt. |

This dope 51 was prepared to have a TAC concentration of approximately 23 wt %. The dope 51 was filtered firstly with a paper filter (63LB, Toyo Roshi Kaisha, Ltd.), secondly with a sintered metal filter (06N, Nippon seisen Co., Ltd., nominal pore diameter 10 μm), and lastly with a mesh filter, and then put in a stock tank.

[Cellulose Triacetate]

The cellulose triacetate of this experiment had those characteristics: a remaining acetic acid content of 0.1 wt % or below; a Ca content rate of 5 ppm; an Mg content rate of 42 ppm; a Fe content rate of 0.5 ppm, and also contains a free acetic acid of 40 ppm and a sulfuric ion of 15 ppm. The degree of acetyl substitution for hydroxyl groups at sixth position was 0.91. The hydroxyl groups at sixth position were substituted in the 32.5% of the whole acetyl groups. The acetone extract in which TAC is extracted by acetone was 8 wt %, and a ratio of weight-average molecular weight to number-average molecular weight was 2.5. Further, yellow index was 1.7, haze was 0.08, and transparency was 93.5%. This TAC was synthesized from cellulose obtained from cotton. Hereafter, this type of TAC is referred to as pulp TAC.

[Experiment 2] to [Experiment 10]

The second to tenth experiments were also conducted under the same conditions as the first experiment, but with different support rollers which were any of the support roller 18 with different Pm and Hv-m and a support roller with no projection. The actual conditions of the support roller in each of the second to tenth experiments are shown in Table 1 below.

Table 1 also shows the results of the following evaluations on the first to tenth experiments. In Table 1, the numbers assigned to the evaluation results correspond to the numbers of the evaluation items.

1. Evaluation of Slippage

A degree of the slippage of the wet film 17 during the conveyance by the support roller 18 was evaluated as:

Excellent: no slippage of the wet film 17 occurred, and no scratch and no wrinkle were seen,

Good: a little slippage occurred, but scratches and wrinkles were little seen,

Poor: slippage occurred, and scratches and wrinkles were seen.

2. Evaluation on Roller Mark Transfer

A degree of the roller marks that was transferred from the support roller 18 to the wet film 17 was evaluated as:

Excellent: no roller mark was seen on the wet film 17,

Good: a few but not-many roller marks were seen on the wet film 17,

Poor: many or serious roller marks were seen on the wet film 17.

TABLE 1

| | | | | Evaluation | |
|---|---|---|---|---|---|
| Experiment | Projection | Pm | Hv-m | 1 | 2 |
| 1 | Present | 1 | 0.5 | Excellent | Excellent |
| 2 | Present | 1 | 0.01 | Good | Good |
| 3 | Present | 1 | 1 | Good | Good |
| 4 | Present | 1 | 0.006 | Poor | Poor |
| 5 | Present | 1 | 3 | Good | Good |
| 6 | Present | 0.01 | 0.5 | Good | Good |
| 7 | Present | 2 | 0.5 | Good | Good |
| 8 | Present | 0.001 | 0.5 | Poor | Poor |
| 9 | Present | 3 | 0.5 | Poor | Poor |
| 10 | Absent | — | — | Poor | Poor |

In the first to third, sixth and seventh experiments, no slippage and no roller mark transfer occurred in the first drying chamber 56. In the tenth experiment, since there is no projection on the support roller, the slippage and the roller mark transfer occurred in the first drying chamber 56. In the fourth, eighth and ninth experiments where the Hv-m was below the predetermined range or the Pm was out of the predetermined range, the cross sectional area of the recess became too small to achieve the air removing effect, and the slippage and the roller mark transfer could not be prevented. In the fifth experiment where the Hv-m was beyond the predetermined range, the slippage and the roller mark transfer were prevented, as with the first to third, sixth and seventh experiments, but the cost and the labor were increased for the production of the roller body.

These results prove that, because of the projections in the edge contact areas, the support roller according to the present invention serves to convey the web without causing the slippage of the web and the roller mark transfer.

Next, to demonstrate the effect of the support roller 136, eleventh to twenty-third experiments were conducted with specific support roller, which were different from the support roller 136 in at least one of presence/absence of the projections 166, values of the pitch Pm, and the height Hv-m and the taper amount (De−Dc)/Dc. Hereafter, the eleventh experiment is described in detail, and the eleventh to twenty-third experiments are only explained about the differences from the eleventh experiment.

[Experiment 11]

A composition of a polymer solution (dope) used for film production is shown below.

[Dope Preparation]

The dope 51 different from the one in the first to tenth experiments was prepared by adding a certain volume of the solid contents (solute) containing:

| | | |
|---|---|---|
| Cellulose triacetate (substitution degree of 2.8) | 89.3 | wt % |
| Plasticizer A (triphenyl phosphate) | 7.1 | wt % |
| Plasticizer B (biphenyl diphenyl phosphate) | 3.6 | wt % |
| into the mixed solvent of: | | |
| Dichloromethane | 80 | wt % |
| Methanol | 13.5 | wt % |
| N-butanol | 6.5 | wt %. |

This dope 51 was prepared to have a TAC concentration of approximately 23 wt %. The dope 51 was filtered firstly with a paper filter (63LB, Toyo Roshi Kaisha, Ltd.), secondly with a sintered metal filter (06N, Nippon seisen Co., Ltd., nominal pore diameter 10 μm), and lastly with a mesh filter, and then put in a stock tank.

[Cellulose Triacetate]

The cellulose triacetate of this experiment was identical to the one used in the first experiment.

As shown in FIG. 10, the film 59 was produced with the solution casting apparatus 110. A pump was used to deliver the dope 51 the casting die 71 by way of a filtering device. The casting die 71 was provided with a jacket (not shown) which contains a temperature-adjustable heat transfer medium, and the dope 51 was kept at the temperature of approximately 34° C.

The rotary shaft 13b is rotated to turn the casting drum 72. The peripheral speed of the surface 113a was regulated to not less than 50 m/min and not more than 200 m/min. The heat transfer medium circulator 129 kept the temperature of the peripheral surface 72a of the casting drum 72 at the range of not less than −10° C. and not more than 10° C. The temperature of the peripheral surface 72a was 0° C. on the center of the width, and the temperature difference to the side edge areas was 6° C. or below.

The oxygen concentration in dry atmosphere around above the drum 82 was kept at 5 vol %. To keep this oxygen concentration, the surrounding air was substituted by nitrogen gas. In addition, to condense and recover the solvent from within the casting device 116, the condenser 32 was provided therein. An outlet temperature of the condenser 87 was set to −3° C.

The dope 51 was cast from the casting die 71 onto the peripheral surface 72a, and the casting film 78 was formed on the peripheral surface 72a. The decompression chamber 126 decreased the pressure on the rear side of the casting bead, and adjusted a difference of pressure on both sides of the casting bead so that the casting bead had a length of 20 mm to 50 mm.

The casting film 78 was cooled down to develop the self-supporting property, and then peeled off as the wet film 52 from the casting drum 72 with the peel roller 85. For prevention purpose of peeling defect, a speed of peeling (peel roller draw) was appropriately regulated within the range of 100.1% to 110% to the speed of the casting drum 72.

The peel roller 85 guided the wet film 52 to the first drying chamber 56. In the first drying chamber 56, the wet film 52 was exposed to dry air at approximately 60° C. until it dried. The wet film 52 was then guided by the support rollers 136 in the first drying chamber 56 to the tenter 57.

In the tenter 57, the wet film 52 was dried in dry air at substantially 120° C. The wet film 52 was conveyed from the tenter 57 to the edge slitting device 58, which cut off the edges 131e (see, FIG. 12) of the wet film 52. The wet film 52 was then conveyed to the second drying chamber 61. Out of the edge slitting device 58, the wet film 52 had a residual solvent content of approximately 3 wt %. In the second drying chamber 61, the wet film 52 was exposed to dry air at approximately 140° C., and dried out into the film 59.

The film 59 was conveyed to the winding chamber 67. The winding chamber 67 was controlled to keep the internal temperature of 28° C. and the internal humidity of 70%. An ionizer (not shown) was also installed in the winding chamber 67 to keep the electrostatic charges of the film 59 in a range of −1.5 kV and +1.5 kV. Lastly, under a certain tension from the press roller 93, the film 59 was wound around the winding roller 92 in the winding chamber 67.

The conditions in the first drying chamber 56 were as follows:

Conveyance tension in the first drying chamber 56: 100 N/m,

Peripheral speed of the support roller 136: 50 m/min,

Width of the wet film 52: 1900 mm,

Thickness of the wet film 52: 160 mm,

Residual solvent content of the wet film 52 which the peel roller 85 has peeled: 250 wt %,

Outer diameter Dc at the center of the support roller 136 in the AX direction: 100-105 mm,

Outer diameter De at the end of the support roller 136 in the AX direction: 105-110 mm, and

Length Le+Lc of the support roller 136 in the AX direction: 2100-2300 mm.

[Evaluation]

In the eleventh experiment, the following evaluations were made.

1. Evaluation of Slippage

A degree of the slippage of the wet film was evaluated as:

Excellent: no slippage of the wet film occurred in the first drying chamber 56,

Good: a little slippage occurred, but no scratch was seen on the film surface,

Poor: slippage occurred, and scratches were seen on the film surface.

2. Measurement of Rtd

Line sensors were introduced to an entrance and an exit of the first drying chamber 56, and measured a width W0 of the wet film 52 at the entrance of the first drying chamber 56, and a width W1 of the wet film 52 at the exit of the first drying chamber 56. Then, a value of W1/W0 was obtained as a dimensional change rate Rtd of the wet film in the AX direction.

3. Measurement of Rmd

A cut-out with a length L0 in the MD direction was made on the wet film 52 immediately in front of the first drying chamber 56. A length L1 of this cut-out in the MD direction was measured on the wet film 52 as it passed the exit of the first drying chamber 56. Then, a value of L1/L0 was obtained as a dimensional change rate Rmd of the wet film in the MD direction.

[Experiments 12] to [Experiment 23]

The twelfth to twenty-third experiments were also conducted under the same conditions as the eleventh experiment, except for presence and absence of the projections, and the values of the pitch Pm, the height Hv-m and (De−Dc)/Dc. The same evaluations as the eleventh experiment were made in every experiment.

TABLE 2

| | | Pm | Hv-m | | | | |
|---|---|---|---|---|---|---|---|
| Ex | Projection | (mm) | (mm) | (De − Dc)/Dc | Rmd | Rtd | Ev |
| 11 | Present | 1 | 0.5 | 0.02 | 1.02 | 0.98 | Excellent |
| 12 | Present | 1 | 0.5 | 0 | 1.09 | 0.91 | Good |
| 13 | Absent | 1 | 0.5 | 0.02 | 1.12 | 0.88 | Poor |
| 14 | Present | 0.01 | 0.5 | 0.02 | 1.02 | 0.98 | Excellent |
| 15 | Present | 2.0 | 0.5 | 0.02 | 1.03 | 0.97 | Excellent |
| 16 | Present | 0.005 | 0.5 | 0.02 | 1.03 | 0.97 | Good |
| 17 | Present | 2.5 | 0.5 | 0.02 | 1.04 | 0.96 | Good |
| 18 | Present | 1 | 0.01 | 0.02 | 1.04 | 0.96 | Good |
| 19 | Present | 1 | 1.5 | 0.02 | 1.05 | 0.95 | Good |
| 20 | Present | 1 | 0.5 | 0.001 | 1.03 | 0.97 | Excellent |
| 21 | Present | 1 | 0.5 | 0.10 | 1.01 | 0.99 | Excellent |
| 22 | Present | 1 | 0.5 | 0.0005 | 1.04 | 0.95 | Good |
| 23 | Present | 1 | 0.5 | 0.12 | 1.02 | 0.91 | Good |

Ex: Experiment
Ev: Evaluation

Table 2 shows the evaluation result for the slippage, and the measurement results of Rmd and Rtd, along with presence and absence of the projections, and the values of the pitch Pm, the height Hv-m and (De−Dc)/Dc.

Table 2 shows the facts that the support roller according to the present invention enables conveying the wet film at high speed, and that within a certain range of the taper amount, this support roller serves to prevent the wet film from stretching during the conveyance. In view of the fact that wet film 52 meandered only in the twenty-third experiment, a preferable taper amount is 0.1 or below in terms of prevention of such meander.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A support roller disposed alongside a conveyance path for a web so as to support said web, comprising:
a roller body in solid cylinder shape, whose peripheral surface includes edge contact areas, said edge contact areas making contact with edges in a width direction of said web; and
a plurality of projections provided in each of said edge contact areas, and formed to extend in a peripheral direction of said roller body, and arranged at intervals in a rotation axis direction of said roller body, and upon being viewed in cross section taken along said rotation axis, each of said projections having an apex of substantially arcuate shape with a curvature radius of not less than 0.1 mm and not more than 0.5 mm, and said intervals being not less than 0.01 mm and not more than 2 mm, and each of said projections having a height of not less than 0.01 mm and not more than 1 mm from said apex to a bottom of a recess formed between adjacent said projections.

2. The support roller of claim 1, wherein said apex projects outward more than a merchandise portion contact area of said roller peripheral surface which makes contact with a merchandise portion that covers all across said web except said edges.

3. The support roller of claim 2, wherein said projections are provided as a group in a first edge contact area on one end of said roller body, and in a second edge contact area on the other end of said roller body, and formed into spirals with opposite curving directions, and said roller body is oriented such that said projection groups come away from each other as said web advances in a conveyance direction.

4. A web conveyance method comprises a step of supporting a web under conveyance having a thickness of not less than 20 μm and not more than 200 μm with use of the support roller as defined in claim 1.

5. A support roller disposed alongside a conveyance path for a web so as to support said web, comprising:
a roller body in solid cylinder shape, whose peripheral surface includes edge contact areas, said edge contact areas making contact with edges in a width direction of said web; and
a plurality of projections provided in each of said edge contact areas, and formed to extend in a peripheral direction of said roller body, and arranged at intervals in a rotation axis direction of said roller body, and upon being viewed in cross section taken along said rotation axis, each of said projections having a flat apex which has a length of not less than 0.05 mm and not more than 0.5 mm in said rotation axis direction, and said intervals being not less than 0.01 mm and not more than 2 mm, and each of said projections having a height of not less than 0.01 mm and not more than 1 mm from said apex to a bottom of a recess formed between adjacent said projections.

6. The support roller of claim 5, wherein said apex projects outward more than a merchandise portion contact area of said roller peripheral surface which makes contact with a merchandise portion that covers all across said web except said edges.

7. The support roller of claim 6, wherein said projections are provided as a group in a first edge contact area on one end of said roller body, and in a second edge contact area on the other end of said roller body, and formed into spirals with opposite curving directions, and said roller body is oriented such that said projection groups come away from each other as said web advances in a conveyance direction.

8. A web conveyance method comprises a step of supporting a web under conveyance having a thickness of not less than 20 μm and not more than 200 μm with use of the support roller as defined in claim 5.

9. A support roller disposed alongside a conveyance path for a web so as to support said web, comprising:
a roller body;
tapered sections disposed on both ends in a rotation axis direction of said roller body, and each provided with an edge contact area which makes contact with one of edges in a width direction of said web, and formed to increase its diameter gradually toward an extreme end of said roller body;
a constant diameter section disposed on the center in said rotation axis direction of said roller body, and provided with a merchandise contact area which makes contact with a merchandise portion that covers all across said web except said edges, and formed to keep a constant diameter throughout its length in said rotation axis direction; and
a plurality of projections provided in said edge contact areas, and formed to extend along a peripheral direction of said roller body, and arranged at regular intervals in said rotation axis direction of said roller body, and when viewed in cross section taken along said rotation axis, said projections having an apex of substantially arcuate shape.

10. The support roller of claim 9, wherein said interval is not less than 0.01 mm and not more than 2 mm, and each said projection has a height of not less than 0.01 mm and not more than 1 mm from said apex to a bottom of a recess which are formed between adjacent said projections.

11. The support roller of claim 9, wherein a calculation value of (De−Dc)/Dc is not less 0.001 and not more than 0.1, where Dc denotes a diameter of said tapered section at a border to said constant diameter section, and De denotes a diameter of said tapered section at said extreme end of said roller body.

12. A solution casting apparatus comprising:
a continuously running support;
a casting film forming device for casting a dope of a polymer and a solvent onto said support so as to continuously form a casting film;
a drying device for drying said casting film which has been peeled off as a wet film from said support; and
the support roller as defined in claim 9, said web comprising said wet film.

13. The solution casting apparatus of claim 12, wherein a temperature of said support is substantially constant in a range of not less than −15° C. and not more than 0° C.

14. The solution casting apparatus of claim 12, wherein said drying device is a pin tenter which holds both edges in a width direction of said wet film, and dries said wet film.

15. A solution casting method comprising steps of:
casting a dope of a polymer and a solvent onto a continuously running support so as to continuously form a casting film;
peeling off said casting film as a wet film from said support;
drying said wet film with a drying device; and
conveying said wet film to said drying device with use of said support roller as defined in claim 9.
